(19) United States
(12) Patent Application Publication
(10) Pub. No.: US 2006/0155855 A1
(43) Pub. Date: Jul. 13, 2006

(54) Apparatus, methods and computer software productus for judging the validity of a server certificate

(76) Inventor: Shinji Hamai, Kadoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/541,215

(22) PCT Filed: Mar. 5, 2004
(86) PCT No.: PCT/JP04/02928

§ 371 Date: Jun. 30, 2005

(30) Foreign Application Priority Data
Apr. 3, 2003 (JP) 2003-100866

(51) Int. Cl. G06F 15/16

(52) U.S. Cl. 709/227

(57) ABSTRACT

A terminal (40a) comprises: a revocation number verification unit (435) that obtains a revocation number from a repository (20) storing such revocation number that is information serving as a criterion for judging the validity of a server certificate (75); a revocation number storage unit (436) that stores the obtained revocation number; a certificate serial number extraction unit (437) that reads out, from the server certificate (75), an identification number for identifying such server certificate (75); a revocation judgment unit (438) that judges the validity of the server certificate (75) by comparing the read-out identification number with the revocation number stored by the revocation number storage unit (436); and a communication unit (420) that establishes a communication with an application server (30a) when the server certificate (75) is judged valid, and does not establish a communication with the application server (30a) when the server certificate (75) is judged invalid.

### TECHNICAL FIELD

The present invention relates to a communication apparatus, a certificate issuing apparatus and a communication system, and the like, and more particularly to a communication apparatus, a certificate issuing apparatus and a communication system, and the like for performing server authentication by use of a server certificate in a communication.

### BACKGROUND ART

As techniques for overcoming the problem of tapping and server spoofing on the Internet at the time of a server-client communication, U.S. Pat. No. 5,657,390 discloses a technique relating to SSL (Secure Socket Layer) and RFC2246 (IETF) discloses a technique relating to TLS (Transport Layer Security), which is an improved version of SSL (these techniques are hereinafter collectively referred to as “SSL”).

FIG. 1 is a block diagram showing the system configuration of a communication system at the time of an SSL communication.

The communication system is comprised of a server certificate generation apparatus 1000 and a repository 2000 which are under the operation of a certificate authority (CA), plural application servers 3000a˜3000k used by application providers, and plural terminals 4000a˜4000n used by users. The repository 2000, and each of the application servers 3000a˜3000k and terminals 4000a˜4000n are connected to the Internet 5000.

The server certificate generation apparatus 1000 is a computer apparatus that (1) issues a CA certificate 6000 for each of the terminals 4000a˜4000n, (2) issues a server certificate 7000 for each of the application servers 3000a˜3000k, and (3) distributes a server certificate revocation list (hereinafter referred to also as “CRL”) 8000 to the repository 2000.

The repository 2000, which is a computer apparatus for distributing a CRL 8000 to each of the terminals 4000a˜4000n at their distribution requests, is comprised of a CRL storage unit 2100 for storing a CRL 8000 distributed from the server certificate generation apparatus 1000 and a communication unit 2200 for sending the CRL 8000 stored in the CRL storage unit 2100 to each of the terminals 4000a˜4000n upon receipt of distribution requests from such terminals 4000a˜4000n.

Each of the application servers 3000a˜3000k is a computer apparatus that distributes a server certificate 7000 to each of the terminals 4000a˜4000n that has made a communication request in an SSL communication, and is made up of a server unit 3100, a server certificate storage unit 3200, and a communication unit 3300.

Each of the terminals 4000a˜4000n is equipped with a client unit 4100, a server certificate verification unit 4200 having a CA certificate storage unit 4210 and a CRL storage unit 4220, a clock 4300, and a communication unit 4400.

Before the terminals 4000a˜4000n start communicating with the application servers 3000a˜3000k, the CA causes the server certificate generation apparatus 1000 to issue server certificates 7000 in advance and distributes such server certificates 7000 to the respective application servers 3000a˜3000k. Each of the application servers 3000a˜3000k stores the distributed server certificate 7000 into the server certificate storage unit 3200.

Also, the CA distributes, to each of the terminals 4000a˜4000n, a CA certificate 6000 including a CA public key which pairs up with a private key of the CA that signs the server certificate 7000. Then, each of the terminals 4000a˜4000n stores the CA certificate 6000 into the CA certificate storage unit 4210.

Meanwhile, the CA checks the invalidity of a server certificate 7000. When judging that such server certificate 7000 is invalid, the CA causes the server certificate generation apparatus 1000 to add the serial number of such server certificate 7000 to the current CRL 8000 so as to generate a new CRL 8000, and distributes it to the repository 2000.

The repository 2000 stores the received CRL 8000 into the CRL storage unit 2100. The terminals 4000a˜4000n regularly request the communication unit 2200 in the repository 2000 to distribute the CRL 8000.

The repository 2000 distributes the CRL 8000 to the respective terminals 4000a˜4000n at their requests. In so doing, the repository 2000 reads the CRL 8000 from the CRL storage unit 2100, and causes the communication unit 2200 to send it to each of the terminals 4000a˜4000n. Each of the terminals 4000a˜4000n stores the received CRL 8000 into the CA certificate storage unit 4210.

FIG. 2 is a list showing an example of the minimum structure of a server certificate 7000 shown in FIG. 1. Note that server certificates are in the x509 format in SSL.

The server certificate 7000 is made up of a version 7001, a serial number 7002, a signature algorithm 7003, an issuer 7004, a validity period 7005, a name 7006, a public key 7007, and a signature 7008.

The version 7001 indicates a version of the x509 format. The serial number 7002 is a unique number to be assigned to the server certificate by the issuer. The signature algorithm 7003 indicates the algorithm used by the issuer in creating a sign. The issuer 7004 is the name of the certificate authority that issued this server certificate. The validity period 7005 indicates the period during which the server certificate remains valid. The name 7006 is the name of a subject for which the server certificate is issued. The public key 7007 is a server public key. And the signature 7008 is a signature created by the CA with its CA private key on the part in this server certificate excluding such signature.

FIG. 3 is a diagram showing an example of the minimum structure of a CRL certificate 8000 shown in FIG. 1.

The CRL 8000 is made up of a version 8001, a signature algorithm 8002, an issuer 8003, update time 8004, next update time 8005, a revoked certificate 8006, a signature algorithm 8007, and a signature 8008.

The version 8001 is the version of this certificate revocation list. The signature algorithm 8002 indicates the algorithm used by the issuer in signing this certificate revocation list. The issuer 8003 indicates the name of the issuing CA of the CRL 8000. The update time 8004 is the date and time of issue of this certificate revocation list. The next update time 8005 is the date and time by which the certificate revocation list will be updated next time. The revoked certificate 8006 is a list of serial numbers 8006b and revocation times 8006b of respective revoked server certificates. Out of server certificates issued by the CA under the name of an issuer, the serial number of each server certificate judged to be invalid by the CA shall be described as a serial number 8006b, together with its revoked time 8006b. The signature algorithm 8007 is the algorithm used by the issuing CA in signing this certificate revocation list. And the signature 8008 is a signature created by the CA with its CA private key on the part in this CRL 8000 excluding such signature.

Next, a description is given of the case where the terminals 4000a˜4000n and the application servers 3000a˜3000k carry out an unencrypted communication.

FIG. 4 is a sequence diagram illustrating the case where an unencrypted communication is carried out. Note that a description is given here of the case where a communication is carried out between the terminal 4000a and the application server 3000a.

In the terminal 4000a, the client unit 4100 indicates the communication unit 4400 to send a request 1 to the application server 3000a (S801). Then, the communication unit 4400 sends the request 1 to the communication unit 3300 of the application server 3000a (S802).

In the application server 3000a, the communication unit 3300 outputs the received request 1 to the server unit 3100 (S803). The server unit 3100 processes such request 1 to generate a response 1, and indicates the communication unit 3300 to send it to the terminal 4000a (S804). Then, the communication unit 3300 sends such response 1 to the communication unit 4400 of the terminal 4000a (S805).

The communication unit 4400 of the terminal 4000a outputs the response 1 to the client unit 4100 (S806).

The communication is carried out in the above sequence without encrypting the request 1 and the response 1.

Next, a description is given of the case where the terminals 4000a˜4000n and the application servers 3000a˜3000k carry out an encrypted communication.

FIG. 5 is a sequence diagram illustrating the case where an encrypted communication is carried out. Note that a description is given here of the case where a communication is carried out between the terminal 4000a and the application server 3000a.

In the terminal 4000a, the client unit 4100 indicates the communication unit 4400 to send a request 2 to the application server 3000a in encrypted form (S900). Then, the communication unit 4400 sends, to the communication unit 3300 of the application server 3000a, a ClientHello packet that includes (1) a client random number to serve as an element of a common key and (2) a type of encryption that the communication unit 4400 can support, so as to start an SSL handshake (S901).

In the application server 3000a, the communication unit 3300 determines the encryption type from the ClientHello packet, generates (1) a server random number to serve as an element of a common key and (2) a session ID for uniquely specifying the communication, and sends the determined encryption type, the server random number and the session ID in a ServerHello packet (S902). Then, the communication unit 3300 reads a server certificate 7000 from the server certificate storage unit 3200 (S903), sends such server certificate 7000 as a Certificate packet to the communication unit 4400 of the terminal 4000a (S904), and sends a ServerHelloDone packet to the communication unit 4400 (S907).

The communication unit 4400 of the terminal 4000a reads the server certificate 7000 from the Certificate packet, and sends it to the server certificate verification unit 4200 (S905). The server certificate verification unit 4200 verifies if such server certificate 7000 is invalid or not, and notifies the communication unit 4400 of the verification result (S906). When the server certificate is invalid, the communication unit 4400 sends an alert packet to the communication unit 3300 of the application server 3000a so as to disconnect the session, and returns an error to the client unit 4100. Meanwhile, when the server certificate is valid, the communication unit 4400 generates a premaster secret used to calculate a common key for encryption, encrypts such premaster secret with the server public key contained in the server certificate 7000, sends, to the communication unit 3300 of the application server 3000a, a ClientKeyExchange packet that includes the encrypted premaster secret after the arrival of the ServerHelloDone packet (S908), and further sends a ChangeCipherSpec packet to the communication unit 3300 (S909). ChangeCipherSpec packet is a packet indicating the initiation of encryption. The communication unit 4400 generates a common key C used for encryption from the client random number, the server random number, and the premaster secret, and encrypts a Finished packet indicating the completion of the handshake with the generated common key C, so as to send such encrypted packet to the communication unit 3300 of the application server 3000a (S910).

The communication unit 3300 of the application server 3000a reads the encrypted premaster secret from the ClientKeyExchange packet, decrypts it with the server private key into the premaster secret, and generates a common key D used for encryption from the decrypted premaster secret, the server random number and the client random number. When an SSL handshake has been conducted normally, the common key C possessed by the communication unit 3300 and the common key D possessed by the communication unit 4400 become the same. The communication unit 3300 decrypts the received Finished packet with the common key D, and when such decryption succeeds, encrypts such Finished packet to send it to the communication unit 4400 of the terminal 4000a (S911). The subsequent communication after this Finished packet shall be carried out in encrypted form.

The communication unit 4400 of the terminal 4000a decrypts the received Finished packet, and sends a request 2 to the communication unit 3300 of the application server 3000a in encrypted form, when such decryption succeeds (S912).

The communication unit 3300 of the application server 3000a decrypts the request 2, and sends the decrypted request 2 to the server unit 3100 (S913). The server unit 3100 processes such request 2 to generate a response 2, and indicates the communication unit 3300 to send it to the terminal 4000a (S914). Then, the communication unit 3300 encrypts the response 2, and sends the encrypted response 2 to the communication unit 4400 of the terminal 4000a (S915).

The communication unit 4400 of the terminal 4000a decrypts the encrypted response 2, and outputs the decrypted response 2 to the client unit 4100 (S916).

The communication is carried out in encrypted form in the above manner.

Next, a description is given of verification performed by the server certificate verification unit 4200.

FIG. 6 is a flowchart showing the operation performed by the server certificate verification unit 4200 when verifying a server certificate 7000.

The server certificate verification unit 4200 reads the validity period 7005 from the received server certificate 7000, and obtains the current time from the clock 4300 (S9051). Then, the server certificate verification unit 4200 compares the current time with the start and expiration dates of the validity period 7005, and notifies the communication unit 4400 of an error code indicating period expiration, when the current time is not within the validity period 7005 of the server certificate 7000, so as to end the verification (S9057).

Meanwhile, when the current time is within the validity period 7005 of the server certificate 7000, the server certificate verification unit 4200 reads the issuer 7004 from the server certificate 7000, and further searches the CA certificate storage unit 4210 for the CA certificate 6000 of such issuer 7004. When there exists the CA certificate 6000 corresponding to the issuer 7004, the server certificate verification unit 4200 reads the CA public key from such CA certificate 6000, and checks the signature 7008 on the server certificate 7000 by use of the CA public key. When the signature 7008 is invalid, the server certificate verification unit 4200 notifies the communication unit 4400 of an error code indicating verification error, and ends the verification (S9057).

When the signature 7008 is valid, the server certificate verification unit 4200 reads the serial number 7002 from the server certificate 7000. Then, the server certificate verification unit 4200 reads the CRL 8000 from the CRL storage unit 4220, and checks whether such serial number 7002 is included in the CRL 8000 or not. When the CRL 8000 includes the serial number 7002, the server certificate verification unit 4200 judges that the server certificate 7000 is revoked, and notifies the communication unit 4400 of an error code indicating revocation, so as to end the verification (S9057). Meanwhile, when the CRL 8000 does not include the serial number 7002, the server certificate verification unit 4200 judges that the server certificate 7000 is valid, and notifies the communication unit 4400 that the verification has ended normally.

As described above, the terminals 4000a˜4000n prevent tapping and server spoofing by carrying out an encrypted communication using SSL at the time of communicating with the application server 3000a˜3000k.

However, the existing methods have the following problems.

First, the size of a CRL is unfixed in the existing communication system, and therefore the size of a CRL becomes enormously larger with the increase in the number of revoked server certificates (a few tens of KB a few hundreds of KB). This causes the problem that a terminal is required to have vast storage capacity for storing such CRL. Furthermore, when the CRL size becomes larger, it takes longer time to check if the serial number of a server certificate is included in the CRL at the time of verifying the server certificate. Moreover, when the CRL size becomes larger, a communication path though which the terminal obtains the CRL from the repository is required to be capable of handling a vast mount of data, and such repository is also required to be capable of storing a vast amount of data.

Furthermore, there is another problem that a terminal is required to have a precise clock for comparing the current time with the validity period of a server certificate at the time of validity period verification.

In other words, in order to communicate with a server apparatus based on a server certificate indicating the validity of such server apparatus, the existing communication system requires a terminal (communication apparatus) to have sufficient resources such as a large memory capacity, a highly-precise clock, and a communication interface.

The present invention has been conceived in view of the above technical problems, and it is an object of the present invention to provide a communication apparatus, a certificate issuing apparatus and a communication system, and the like capable of communicating with a server apparatus by use of a small amount of resources, based on a server certificate that indicates the validity of such server apparatus.

### DISCLOSURE OF THE INVENTION

In order to achieve the above object, the communication apparatus according to the present invention is a communication apparatus for communicating with a server apparatus based on a server certificate that indicates validity of said server apparatus, comprising: a revocation number obtainment unit operable to obtain a revocation number from a repository apparatus storing said revocation number that is information serving as a criterion for judging validity of the server certificate; a revocation number storage unit operable to store the obtained revocation number; an identification number reading unit operable to read out, from the server certificate, an identification number used to identify said server certificate; a certificate judgment unit operable to judge the validity of the server certificate by comparing the read-out identification number with the revocation number stored by the revocation number storage unit; and a communication control unit operable to establish a communication with the server apparatus when the server certificate is judged to be valid, and operable not to establish a communication with the server apparatus when the server certificate is judged to be invalid.

More specifically, the certificate judgment unit may judge that the server certificate is valid, when the identification number is equal to or larger than the revocation number.

Accordingly, it becomes unnecessary to (1) judge whether the validity period of a server certificate has expired or not by use of a clock, as has been required conventionally, or (2) obtain and store a large-sized CRL from the repository and search for the identification number of the server certificate from among such large-size CRL, as has been required conventionally. This enables the communication apparatus to obtain only one revocation number from the repository and judge whether all server certificates are valid or not by use of such revocation number. Accordingly, the communication apparatus and the repository are required to be equipped only with a small amount of resources (e.g. memory capacity), which makes it possible for the communication apparatus to communicate with the server apparatus based on the server certificate indicating the validity of such server apparatus.

Also, the communication apparatus with the above structure may further comprise a revocation number judgment unit operable to judge validity of the revocation number, wherein the certificate judgment unit judges the validity of the server certificate by use of the revocation number, when the revocation number judgment unit judges that the revocation number is valid. More specifically, the revocation number judgment unit may judge the validity of the revocation number by comparing an identification number of a repository certificate indicating validity of the repository apparatus with the revocation number stored by the revocation number storage unit. Furthermore, the revocation number judgment unit may judge that the repository apparatus is valid, when the identification number of the repository certificate is equal to or larger than the revocation number stored by the revocation number storage unit.

Accordingly, it becomes possible for the communication apparatus to (1) obtain the repository certificate in the same manner as is used when communicating with the server apparatus so as to authenticate the repository by use of such repository certificate, (2) obtain the revocation number in an encrypted commucation when the repository is valid, and (3) obtain only a valid revocation number so as to judge whether all server certificates are valid or not by use of such revocation number.

Moreover, the revocation number judgment unit may judge the validity of the revocation number obtained by the revocation number obtainment unit by comparing said revocation number obtained by the revocation number obtainment unit with the revocation number stored by the revocation number storage unit. More specifically, the revocation number judgment unit may judge that the revocation number obtained by the revocation number obtainment unit is valid, when said obtained revocation number is equal to or larger than the revocation number stored by the revocation number storage unit.

Accordingly, it becomes possible for the communication apparatus to obtain the revocation number in an unencrypted communication when the repository is valid, and to obtain only a valid revocation number so as to judge whether all server certificates are valid or not by use of such revocation number.

What is more, the certificate issuing apparatus according to the present invention is a certificate issuing apparatus for issuing a server certificate indicating validity of a server apparatus, comprising: a revocation number storage unit operable to store a revocation number that is information serving as a criterion for judging validity of the server certificate; and an issuing unit operable to issue a new server certificate, wherein the issuing unit issues the new server certificate that includes an identification number indicating a value which is equal to or larger than the revocation number stored by the revocation number storage unit.

More specifically, the certificate issuing apparatus with the above structure further comprises a revocation number update unit operable to update the revocation number stored by the revocation number storage unit to a number larger than an identification number of a server certificate to be revoked, when notified of said identification number of the server certificate to be revoked.

Accordingly, it becomes unnecessary to have the communication apparatus (1) judge whether the validity period of a server certificate has expired or not by use of a clock, as has been required conventionally, or (2) obtain and store a large-sized CRL from the repository and search for the identification number of the server certificate from among such large-size CRL, as has been required conventionally. This enables the communication apparatus to obtain only one revocation number from the repository and judge whether all server certificates are valid or not by use of such revocation number. Accordingly, the communication apparatus and the repository are required to be equipped only with a small amount of resources (e.g. memory capacity), which makes it possible for the communication apparatus to communicate with the server apparatus based on the server certificate indicating the validity of such server apparatus.

Furthermore, the certificate issuing apparatus with the above structure further comprises a revocation number update unit operable to specify an identification number of a server certificate, an expiration date of which is approaching, and update the revocation number stored by the revocation number storage unit to a number larger than said identification number.

Accordingly, it becomes possible to revoke a server certificate which is close to expiring.

Also, the issuing unit issues the new server certificate for a server apparatus with a server certificate that is assigned an identification number smaller than the updated revocation number, in the case where the revocation number update unit updates the revocation number stored by the revocation number storage unit.

Accordingly, it becomes possible for the server apparatus to be authenticated based on its new server certificate.

As is obvious from the above description, according to the communication apparatus of the present invention, it becomes unnecessary to (1) judge whether the validity period of a server certificate has expired or not by use of a clock, as has been required conventionally, or (2) obtain and store a large-sized CRL from the repository and search for the identification number of the server certificate from among such large-size CRL, as has been required conventionally. This enables the communication apparatus to obtain only one revocation number from the repository and judge whether all server certificates are valid or not by use of such revocation number. Accordingly, the communication apparatus and the repository are required to be equipped only with a small amount of resources (e.g. memory capacity), which makes it possible for the communication apparatus to communicate with the server apparatus based on the server certificate indicating the validity of such server apparatus.

Also, according to the communication apparatus of the present invention, it becomes possible for the communication apparatus to (1) obtain the repository certificate in the same manner as is used when communicating with the server apparatus so as to authenticate the repository by use of such repository certificate, (2) obtain the revocation number in an encrypted commucation when the repository is valid, and (3) obtain only a valid revocation number so as to judge whether all server certificates are valid or not by use of such revocation number.

Moreover, according to the communication apparatus of the present invention, it becomes possible to obtain the revocation number in an unencrypted communication when the repository is valid, and to obtain only a valid revocation number so as to judge whether all server certificates are valid or not by use of such revocation number.

What is more, according to the certificate issuing apparatus of the present invention, it becomes unnecessary to have the communication apparatus (1) judge whether the validity period of a server certificate has expired or not by use of a clock, as has been required conventionally, or (2) obtain and store a large-sized CRL from the repository and search for the identification number of the server certificate from among such large-size CRL, as has been required conventionally. This enables the communication apparatus to obtain only one revocation number from the repository and judge whether all server certificates are valid or not by use of such revocation number. Accordingly, the communication apparatus and the repository are required to be equipped only with a small amount of resources (e.g. memory capacity), which makes it possible for the communication apparatus to communicate with the server apparatus based on the server certificate indicating the validity of such server apparatus.

Also, according to the certificate issuing apparatus of the present invention, it becomes possible to revoke a server certificate which is close to expiring.

Also, according to the certificate issuing apparatus of the present invention, it becomes possible for the server apparatus to be authenticated based on a new server certificate.

Thus, the present invention, which requires only an extremely small amount of resources for performing server authentication, is extremely useful in the present day, when there is a widespread use of the Internet and when networked appliances and the like with a small amount of resources are coming along in the market.

Note that not only is it possible to embody the present invention as a communication apparatus and a certificate issuing apparatus with the above structure, but also as a communication system comprised of a server apparatus, a certificate issuing apparatus for issuing a server certificate indicating the validity of the server apparatus, and a communication apparatus that communicates with the server apparatus based on such server certificate. Furthermore, the present invention can also be embodied as a communication method that includes, as its steps, the characteristic units equipped to the communication apparatus and the certificate issuing apparatus with the above structure, and further as a program that causes a computer to execute such steps. It should be also noted that it is possible to distribute this program via a recording medium such as a CD-ROM and over a transmission medium such as the Internet.

As further information about the technical background to this application, Japanese Patent application No. 2003-100866 filed on Apr. 3, 2003 is incorporated herein by reference.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the system configuration of a communication system at the time of an SSL communication;

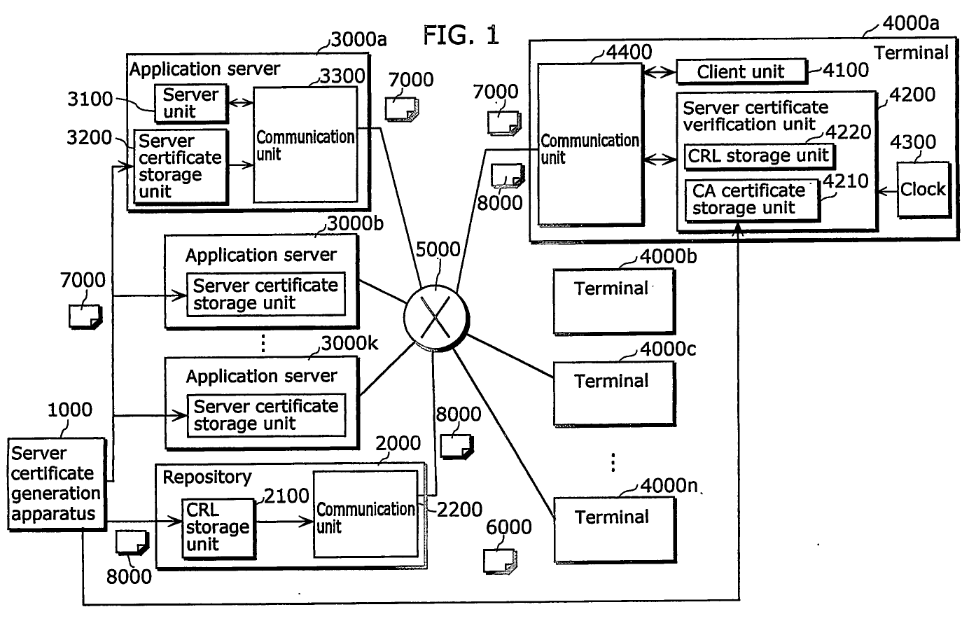

FIG. 2 is a list showing an example of the minimum structure of a server certificate 7000 shown in FIG. 1;

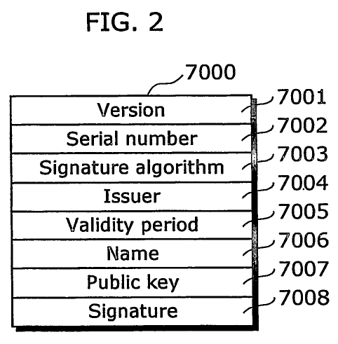

FIG. 3 is a diagram showing an example of the minimum structure of a CRL certificate 8000 shown in FIG. 1;

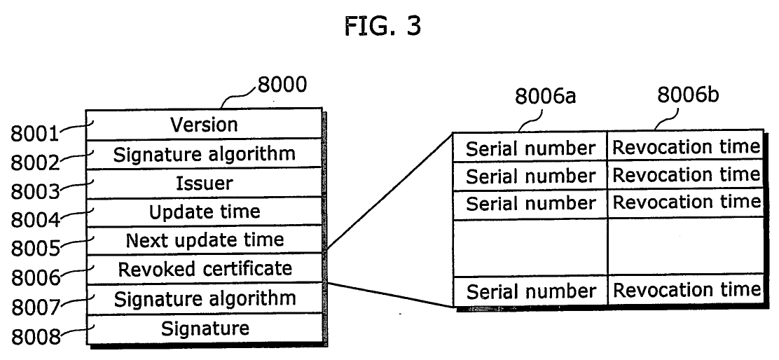

FIG. 4 is a sequence diagram illustrating the case where an unencrypted communication is carried out;

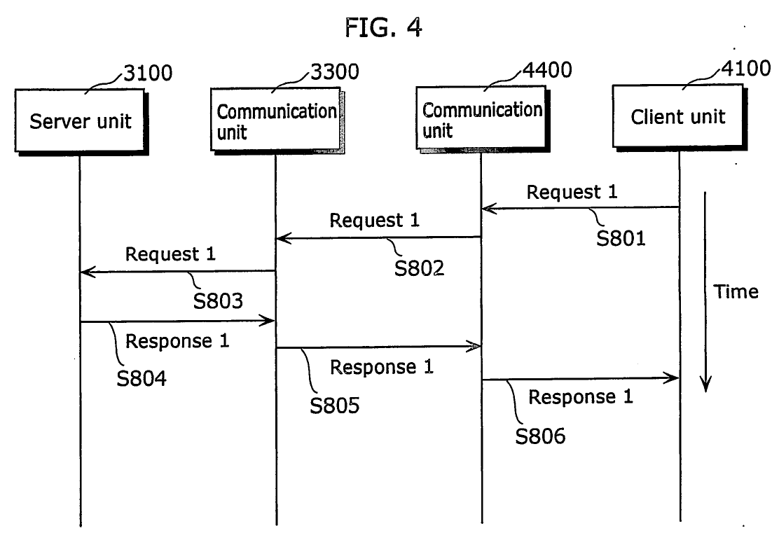

FIG. 5 is a sequence diagram illustrating the case where an encrypted communication is carried out;

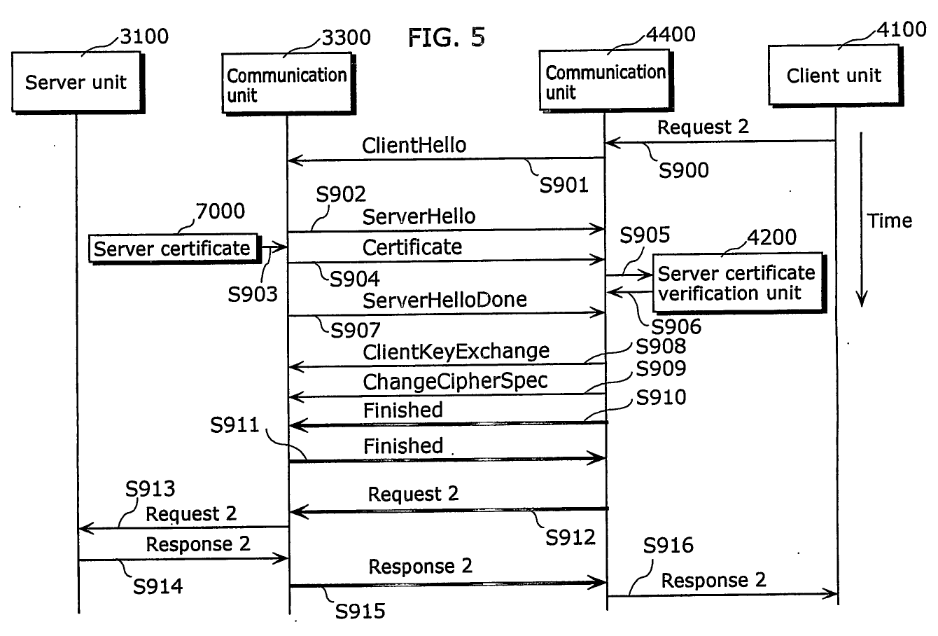

FIG. 6 is a flowchart showing the operation performed by a server certificate verification unit 4200 when verifying a server certificate 7000;

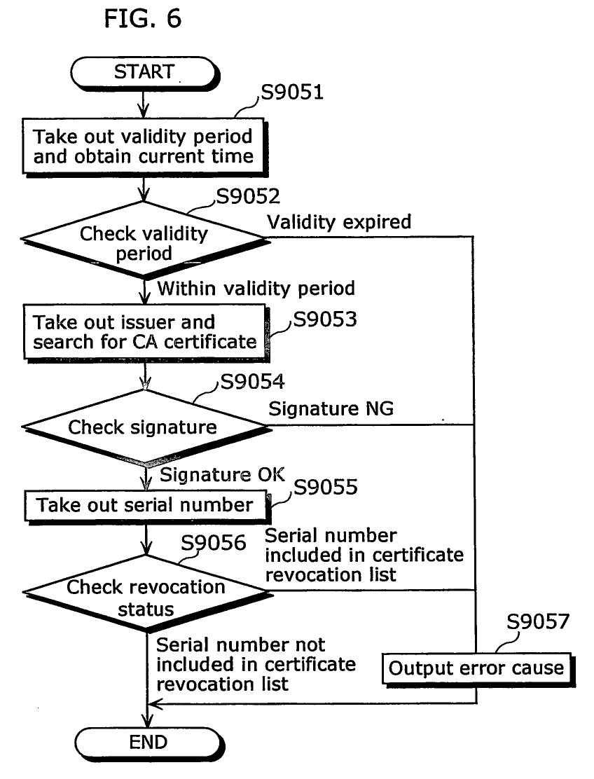

FIG. 7 is a block diagram showing an overall configuration of a communication system 1 according to a first embodiment of the present invention;

FIG. 8 is a diagram showing an example structure of a server certificate 75 shown in FIG. 7;

FIG. 9 is a diagram showing an example structure of revocation information 90 shown in FIG. 7;

FIG. 10 is a diagram showing an example structure of a server certificate history table 110a shown in FIG. 7;

FIG. 11 is a flowchart showing an operation performed by a server certificate formation unit 107 when setting a serial number to a server certificate;

FIG. 12 is a flowchart showing an operation performed by a server certificate validity period search unit 111 when conducting certificate validity period management;

FIG. 13 is a flowchart showing an operation performed by a revoked certificate search unit 113 when searching for a revoked certificate due to the coming of its validity period;

FIG. 14 is a flowchart showing an operation performed by the revoked certificate search unit 113 when searching for a revoked certificate, in response to a revocation notification;

FIG. 15 is a flowchart showing an operation performed by a revocation information signature unit 116 when forming revocation information;

FIG. 16 is a flowchart showing an operation performed by each unit in a server certificate verification unit 430 when obtaining revocation information;

FIG. 17 is a sequence diagram showing the case where an encrypted communication is carried out;

FIG. 18 is a flowchart showing an operation performed by the server certificate verification unit 430 when verifying a server certificate 75;

FIG. 19 is a diagram showing a relationship between serial numbers of server certificates 75 and the revocation number, when there are four servers; and

FIG. 20 is a block diagram showing an overall configuration of a communication system 2 according to a second embodiment of the present invention.

### BEST MODE FOR CARRYING OUT THE INVENTION

### First Embodiment

The following describes the communication system according to the first embodiment of the present invention.

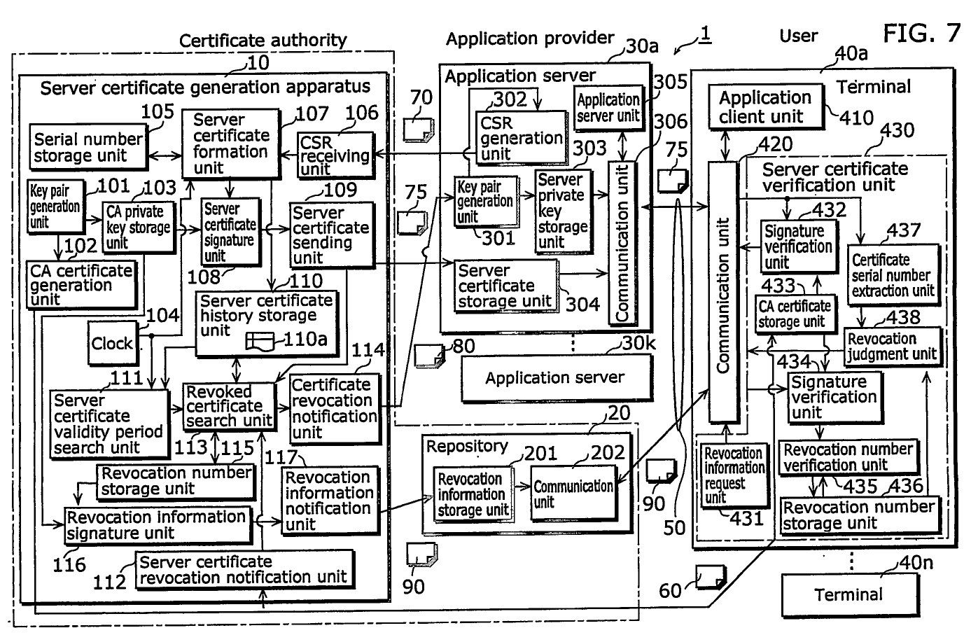

FIG. 7 is a block diagram showing an overall configuration of a communication system 1 according to the first embodiment of the present invention.

The communication system 1 is a system for authenticating an application server using a CA certificate 60, a server certificate 75 and revocation information 90 as basic tools, with the view to providing a public key infrastructure (PKI) for ensuring safe communication using a public key encryption method. Such communication system 1 is comprised of a server certificate generation apparatus 10 and a repository 20 which are used by a certificate authority (hereinafter referred to also as “CA”), a plurality of application servers 30a˜30k used by providers of applications such as video content, a plurality of terminals 40a˜40n used by users, and the Internet 50 that connects the repository 20, the application servers 30a˜30k and the terminals 40a˜40n with each other. Note that since each of the application servers 30a˜30k has the same structure, a detailed structure of only the application server 30a is illustrated in the diagram. Similarly, since each of the terminals 40a˜40n has the same structure, a detailed structure of only the terminal 40a is illustrated in the diagram.

The server certificate generation apparatus 10, which is a computer apparatus, functions as a basic server for providing the basic tools used in the communication system 1. More specifically, the server certificate generation apparatus 10 (1) issues a CA certificate 60 to each of the terminals 40a˜40n in advance, (2) issues, at a certificate signing request (hereinafter referred to also as “CSR”) 70 from each of the application servers 30a˜30k, a server certificate 75 that is dedicated to each of the application servers 30a˜30k and that includes a serial number which increments by “1” starting from “0” and which is unique to the system, (3) gives advance notice to an application server about certification revocation (certificate renewal request) in the case where the server certificate 75 of such application server is to be revoked when, for example, its server certificate 75 is close to expiring, and (4) sends, to the repository 20, revocation information 20 including a serial number (hereinafter referred to also as “revocation serial number” or “revocation number”) that needs to increment by a monotonous number starting from “0” and that is used when a judgment is made on whether a server certificate 75 is revoked or not.

Note that a CA certificate 60 includes, for example, the issuer of such certificate, its signature algorithm, the validity period of this certificate (e.g. ten years), the public key of the CA (CA public key), and a signature created by the private key of the CA (CA private key) paired with such CA public key. Meanwhile, a CSR 70 includes, for example, the name of a server making this CSR and the public key of such server (server public key).

The repository 20, which is a computer apparatus, stores the latest revocation information 90 notified from the server certificate generation apparatus 10. Upon a request for the revocation information 90 from any one of the terminals 40a˜40n via the Internet, the repository 20 distributes, as a response, the revocation information 90 to the requesting terminal in an unencrypted communication.

Each of the application servers 30a˜30k is a computer apparatus, and makes a CSR 70, to the server certificate generation apparatus 10, that includes the name of a server and the public key of such server when necessary (e.g. when there is a certificate revocation notification from the server certificate generation apparatus 10), and holds the server certificate 75 issued by the server certificate generation apparatus 10 exclusively to each of the application servers 30a˜30k, Upon a request from any one of the terminals 40a˜40n for downloading its application, each of the application servers 30a˜30k sends its server certificate 75 according to the SSL communication protocol, and distributes, as a response, the requested application in an encrypted communication using a session key (common key), after server certificate 75 is authenticated. Note that the procedure equivalent to the conventional procedure is used when a communication is carried out in unencrypted form.

Each of the terminals 40a˜40n, which is a computer apparatus such as a networked appliance (e.g. video decoder), obtains in advance the CA certificate 60 issued by the server certificate generation apparatus 10 and stores it. Furthermore, each of the terminals 40a˜40n regularly (e.g. once a month) requests the communication unit 202 of the repository 20 to distribute revocation information 90, and stores the latest revocation number included in such distributed revocation information 90. Then, when downloading an application from any one of the application servers 30a˜30k, each of the terminals 40a˜40n authenticates the server based on the server certificate 75 sent from such server, the pre-stored CA certificate 60, and the revocation number in the revocation information 90, according to an SSL communication protocol. Then, after authenticating the server, each of the terminals 40a˜40n exchanges requests and responses in an encrypted communication using the session key.

Accordingly, it becomes possible to prevent tapping of requests and responses.

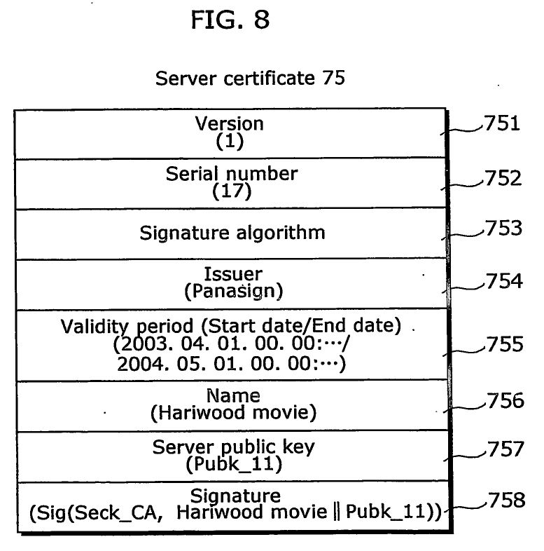

FIG. 8 is a diagram showing an example structure of a server certificate 75 shown in FIG. 7. Note that this server certificate 75 is also in the x509 format as in the conventional method.

Such server certificate 75 is made up of the following fields: a version 751, a serial number 752, a signature algorithm 753, an issuer 754, a validity period 755, a server name 756, a server public key 757, and a signature 758.

The version 751 indicates a version of the x509 format, where “1” is stored, for example. The serial number 752 is a unique number to be assigned to the server certificate by the issuer, where “17” is stored, for example. The signature algorithm 753 indicates the algorithm used by the issuer in signing this server certificate. The issuer 754 is the name of the certificate authority that issued this server certificate, where “Panasign” is stored, for example. The validity period 755 indicates the period during which the server certificate remains valid, where the following is stored, for example: the date and time by which the server certificate 75 was issued (the start date of the validity period, 2003.04.01 . . . ) and the date and time thirteen months after that (the end date of the validity period, 2004.05.01 . . . ). The name 756 is the name of a subject for which the server certificate is issued, where “Hariwood movie” is stored, for example. The server public key 757 is a server public key, where the public key of the Hariwood movie “Pubk_{—}11” is stored, for example. And the signature 758 is a signature on the characteristics of the part excluding the signature of this server certificate, so-called fingerprint, where the following is stored, for example: the value obtained by encrypting, with the CA private key, the combination of the server name “Hariwood movie” and the server public key “Pubk_{—}11”.

Accordingly, each of the terminals 40a˜40n that has received the server certificate 75 with the above structure from the corresponding application server, can verify if such server certificate 75 is an authorized certificate issued by the CA, by decrypting its signature 758 with the CA public key.

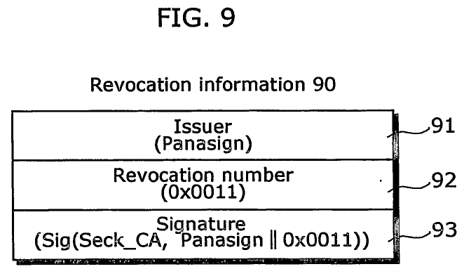

FIG. 9 is a diagram showing an example structure of revocation information 90 shown in FIG. 7.

As FIG. 9 shows, such revocation information 90 is made up of the following fields: an issuer 91, a revocation number 92, and a signature 93.

The issuer 91, which is the name of the certificate authority that issued this revocation information 90, is the same as the issuer 754 included in a server certificate 75 to be described in the revocation information 90. “Panasign” is stored in this field. The revocation number 92 is the smallest valid serial number at that point of time among those of server certificates 75 issued by the issuing CA. Only “0x0011”, for example, is stored in this field. And the signature 93 is a signature on the characteristics of the part excluding the signature of this server certificate, i.e., the signature created for the issuer 91 and the revocation number 92. The value obtained by encrypting, with the CA private key, the combination of the issuer 91 and the revocation number 92 is stored, for example.

Accordingly, each of the terminals 40a˜40n that has received the revocation information 90 with the above structure from the repository 20, can verify if such revocation information 90 is authorized information issued by the CA, by decrypting its signature 93 with the CA public key and can judge if the server certificate 75 received from the application server is revoked or not by comparing the numerical size of the serial number of such server certificate 75 with the numerical size of the revocation number 92.

Next, a detailed description is given of each structure of the server certificate generation apparatus 10, the repository 20, the application servers 30a˜30k, and the terminals 40a˜40n.

As FIG. 7 shows, the server certificate generation apparatus 10 is formed of a key pair generation unit 101, a CA certificate generation unit 102, a CA private key storage unit 103, a clock 104, a serial number storage unit 105, a CSR receiving unit 106, a server certificate formation unit 107, a signature unit 108, a server certificate sending unit 109, a server certificate history storage unit 110, a server certificate validity period search unit 111, a server certificate revocation notification unit 112, a revoked certificate search unit 113, a certificate revocation notification unit 114, a revocation number storage unit 115, a revocation information signature unit 116, and a revocation information notification unit 117, and the like.

The key pair generation unit 101 generates a CA private key used for signing a server certificate 75 and a CA public key used for verifying signatures. Then, the key pair generation unit 101 outputs, to the CA certificate generation unit 102, such generated CA public key and CA private key, and further outputs the CA private key to the CA private key storage unit 103.

The CA certificate generation unit 102 generates a CA certificate 60 from the CA public key and the like generated by the key pair generation unit 101 and the signature created by use of the CA private key generated by the key pair generation unit 101, and sends the generated CA certificate 60 to each of the terminals 40a˜40n.

The CA private key storage unit 103 stores the CA private key generated by the key pair generation unit 101.

The clock 104 precisely indicates the current time.

The serial number storage unit 105 stores a serial number to be assigned to the next server certificate 75 to be issued. More specifically, when the server certificate generation apparatus 10 has already issued the server certificate 75 with the serial number of “4”, the serial number storage unit 105 shall store the serial number “5”. Note that the default serial number stored by the serial number storage unit 105 is “0”.

Upon receipt of a CSR 70 from each of the application servers 30a˜30k, the CSR receiving unit 106 outputs such received CSR 70 to the server certificate formation unit 107. Note that each CSR 70 includes the server name and the server public key.

The server certificate formation unit 107 puts together pieces of information necessary for a server certificate 75. More specifically, the server certificate formation unit 107 sets the following information: the serial number read out from the serial number storage unit 105 as a serial number 752; the current time obtained from the clock 104 as the start date and time of a validity period 755; and the date and time thirteen months after the current time as the end date of the validity period 755, i.e. the expiration date. Then, the server certificate formation unit 107 sets the name and server public key contained in the CSR 70 as a name 756 and a server public key 757 respectively, and sets a predetermined version, issuer, and signature algorithm as a version 751, an issuer 754, and a signature algorithm 753 respectively, so as to output such necessary information for the server certificate 75 to the signature unit 108.

After putting together the necessary information for the server certificate 75, the server certificate formation unit 107 outputs the name 756, the serial number 752, and the end date of the validity period 755 (expiration date) out of such necessary information for the server certificate 75, and stores the outputted information into the server certificate history table 110a of the server certificate generation apparatus 10. Furthermore, the server certificate formation unit 107 has the serial number storage unit 105 store the value obtained by adding 1 to the serial number of the server certificate 75 to be issued (e.g. “16 (0x0010)” is stored when the serial number of a newly issued server certificate 75 is “17 (0x001)”), as the serial number to be assigned next.

The signature unit 108 reads the CA private key from the CA private key storage unit 103, and generates a signature 758 by associating such read-out CA private key with the version 751, the serial number 752, the signature algorithm 753, the issuer 754, the validity period 755, the name 756, and the server public key 757 which have been outputted from the server certificate formation unit 107. Then, after completing the server certificate 75, the signature unit 108 outputs such server certificate 75 to the server certificate sending unit 109.

The server certificate sending unit 109 sends the server certificate 75 outputted from the signature unit 108 to an application server that has made the CSR 70. In so doing, the server certificate sending unit 109 notifies the revoked certificate search unit 113 that the new server certificate 75 is to be sent.

The server certificate history storage unit 110 sequentially stores the name, the server serial number, and the validity period of a server into the server certificate history table 110a, every time the server certificate formation unit 107 forms a new server certificate 75.

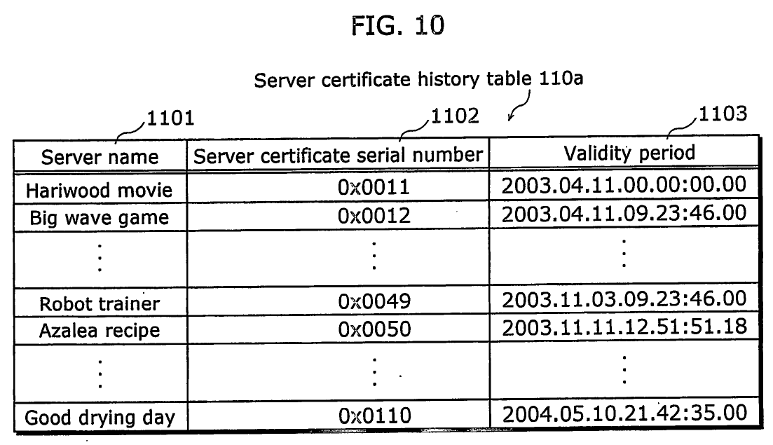

FIG. 10 is a diagram showing an example structure of the server certificate history table 110a stored in the server certificate history storage unit 110.

As FIG. 10 shows, the server certificate history table 110a is made up of plural records and fields that store each of the following information relating to the respective server certificates 75 which are currently valid in the communication system 1: server names 1101; server certificate serial numbers 1102; and validity periods 1103.

The use of the server certificate history table 110a with the above structure makes it possible to (1) specify the application servers 30a˜30k with server certificates 75, based on the respective server names 1101, (2) specify the minimum serial number (“Se min” being illustrated as “0x0011” in the diagram) and the maximum serial number (“Se max” being illustrated as “0x0110” in the diagram) out of the serial numbers of the currently valid server certificates 75, based on the serial numbers 1102, and (3) manage revocation and the like of server certificates which is caused by the coming of their expiration dates.

The server certificate validity period search unit 111 regularly referrers to the validity periods described in the server certificate history table 110a stored in the server certificate history storage unit 110, so as to search for server certificates 75 whose validities expire within a month. More specifically, the server certificate validity period search unit 111 reads out the current time from the clock 104, so as to search for server certificates 75 whose validities expire within a month from such current time. If there exist any server certificates 75 whose validities expire within a month from the current time, the server certificate validity period search unit 111 notifies the revoked certificate search unit 113 of the serial number of the server certificate 75 with the largest serial number, as a serial number to be actually revoked (e.g. in FIG. 10, when the expiration dates of “Hariwood movie” and “Big wave game” come in one month, the serial number “0x0012” of “Big wave game” which is assigned a larger value, shall be notified to the revoked certificate search unit 113).

The server certificate revocation notification unit 112 accepts the serial number of the server certificate 75 to be revoked, and notifies the revoked certificate search unit 113 of such serial number. Stated another way, the CA always checks the security of the server certificates 75 of application servers, and accepts, from the server certificate revocation notification unit 112, the serial number of a server certificate 75 to be revoked (e.g. in FIG. 10, when the server certificate 75 of “Robot trainer” is to be revoked, its serial number “0x0049” is to be accepted) as a serial number to be actually revoked, when at least one of the following cases (1)˜(3) applies, for example:
(1) the server private key of an application server is exposed;
(2) an application server stops operating; and
(3) the name of an application server is changed.

The revoked certificate search unit 113 lists all serial numbers in the server certificate history table 110a that are equal to or smaller than the serial number to be revoked notified from the server certificate validity period search unit 111 or the server certificate revocation notification unit 112, and notifies the certificate revocation notification unit 114 of the server names corresponding to all of such serial numbers. Then, after updating all the server certificates 75 corresponding to the listed serial numbers, the revoked certificate search unit 113 updates the revocation number into the value that is obtained by adding “1” to the maximum serial number value among those of the server certificates to be revoked, and stores such updated revocation number into the revocation number storage unit 115. Furthermore, after updating all the server certificates 75 corresponding to the above-listed serial numbers, the revoked certificate search unit 113 deletes, from the server certificate history storage unit 110, information concerning the server certificates 75 corresponding to such listed serial numbers.

The certificate revocation notification unit 114 requests applications servers, out of the applications servers 30a˜30k, with the names notified from the revoked certificate search unit 113 to renew their server certificates 75. Such application servers renew their server certificates 75 in response to such request for renewing the server certificates. When this is done, the server certificate sending unit 109 notifies the revoked certificate search unit 113 that the renewed server certificates 75 will be sent.

The revocation number storage unit 115 stores, as the revocation number, a serial number which is currently valid and smallest of all the serial numbers of the server certificates 75 sent from the server certificate sending unit 109. Note that the default revocation number is “0”. The revocation number stored in the revocation number storage unit 115 is then sent to the revocation information signature unit 116.

The revocation information signature unit 116 forms revocation information 90 by putting together the issuer 91, the revocation number 92, and the signature which are necessary for the revocation information 90, and outputs such revocation information 90 to the revocation information notification unit 117. Note that the signature 93 is generated by encrypting the combination of the issuer 91 and the revocation number 92 with the CA private key stored in the CA private key storage unit 103.

The revocation information notification unit 117 notifies the repository 20 of the revocation information 90.

The repository 20 is made up of the revocation information storage unit 201 and the communication unit 202.

Upon receipt of the revocation information 90 from the server certificate generation apparatus 10, the revocation information storage unit 201 of the repository 20 stores such received revocation information 90.

The communication unit 202 is an interface for communicating with the terminals 40a˜40n via the Internet 50 according to the above-described protocol and the like for unencrypted communication. When there is a request from any one of the terminals 40a˜40n to distribute the revocation information 90, the communication unit 202 sends the revocation information 90 stored in the revocation information storage unit 201 to each of the terminals that have made the request. This communication is not required to be encrypted. Also, the repository 20 is not required to be performed of server authentication.

Each of the application servers 30a˜30b is made up of a key pair generation unit 301, a CSR generation unit 302, a server private key storage unit 303, a server certificate storage unit 304, an application server unit 305, and a communication unit 306.

The key pair generation unit 301 generates a server public key and a server private key, which are a pair of keys used for encryption and decryption using RSA encryption technology, when each of the application servers 30a˜30k is installed.

The CSR generation unit 302 generates a template used for requesting the CA to generate a server certificate 75, i.e. a CSR 70 that includes the server public key and the server name, and sends such generated CSR 70 to the server certificate generation apparatus 10.

The server private key storage unit 303 stores the server private key generated by the key pair generation unit 301.

The server certificate storage unit 304 stores the server certificate 75 received from the server certificate generation apparatus 10.

Upon receipt of a request from the server certificate generation apparatus 10 to renew the server certificate 75, the key pair generation unit 301 generates a new server public key and a new server private key, and the CSR generation unit 302 generates a CSR 70 using such new server public key, as in the case where the server is installed, so as to request the server certificate generation apparatus 10 to generate a new server certificate 75. Then, the server certificate storage unit 304 receives and stores the new server certificate 75 from the server certificate generation apparatus 10.

The application server 305 processes the CSR 70 received via the communication unit 306 so as to generate a response, and outputs such generated response to the communication unit 306.

The communication unit 306 is an interface for communicating with the terminals 40a˜40n via the Internet 50 according to the above-described protocol for encryption, and the like. The communication unit 306 (1) analyzes a request/command sent from each of the terminals 40a˜40n, (2) reads a server certificate 75 from the server certificate storage unit 304 for performing server authentication according to the result of such analysis, so as to send the read-out server certificate 75 to the corresponding terminal, (3) decrypts, with the server private key stored in the server private key storage unit 303, an encryption type received from the terminal, so as to generate a common key used for an encrypted communication, (4) decrypts a request and outputs the decrypted request to the application server 305, when receiving a request from any of the terminals 40a˜40n in an encrypted communication, and (5) encrypts a response requested by the application server 305, and outputs the encrypted response to the corresponding terminal.

Each of the terminals 40a˜40n is made up of an application client unit 410, a communication unit 420, and a server certificate verification unit 430.

The application client unit 410 outputs a request to each of the application servers 30a˜30k and receives a response from each of the application servers 30a˜30k.

The communication unit 420 is an interface for communicating with the application servers 30a˜30k and the repository 20 via the Internet 50 according to the above-described protocol for encrypted or unencrypted communication, and the like. The communication unit 420 (1) analyzes a command sent from each of the application servers 30a˜30k, (2) requests the server certificate verification unit 430 for processing, according to the result of such analysis, (3) sends data passed from the client unit 410 and server certificate verification unit 430 to the corresponding application server, (4) sends data passed from the server certificate verification unit 430 to the repository 20, and (5) receives revocation information 90 from the repository 20.

More specifically, the communication unit 420 requests the communication unit 306 to start an encrypted communication. Then, the communication unit 420 receives the server certificate 75 from the communication unit 306, and outputs the received server certificate 75 to the server certificate verification unit 430. When notified of abnormality or revocation of such server certificate 75 from the server certificate verification unit 430, the communication unit 420 notifies the communication unit 306 of such abnormality of the server certificate 75, so as to disconnect the session, and notifies the application client unit 410 of an error. Meanwhile, when the signature on the server certificate 75 is normal and such server certificate 75 is not revoked, the communication unit 420 generates a premaster secret, encrypts such premaster secret with the server public key contained in the server certificate 75, and sends the encrypted premaster secret to the communication unit 306. Furthermore, the communication unit 420 generates an encryption key for an encrypted communication using data obtained so far, so as to carry out the subsequent communication in encrypted form using such encryption key. Moreover, the communication unit 420 requests the communication unit 202 of the repository 20 to distribute the revocation information 90, and outputs the revocation information 90 received from the repository 20 to the signature verification unit 434.

The server certificate verification unit 430 is made up of a revocation information request unit 431, a signature verification unit 432, a CA certificate storage unit 433, a signature verification unit 434, a revocation number verification unit 435, a revocation number storage unit 436, a certificate serial number extraction unit 437, and a revocation judgment unit 438, and the like.

The revocation information request unit 431 requests the communication unit 420 to regularly obtain the revocation information 90 from the repository 20.

Upon receipt of the server certificate 75 from the communication unit 420, the signature verification unit 432 reads the CA public key from the CA certificate storage unit 433, verifies the signature on the server certificate 75 using such CA public key, and notifies the communication unit 420 if the signature is abnormal.

The CA certificate storage unit 433 pre-stores the CA certificate 60 obtained from the server certificate generation apparatus 10.

Upon receipt of the revocation information 90 from the communication unit 420, the signature verification unit 434 reads the CA public key from the CA certificate storage unit 433, verifies the signature on the revocation information 90 using such CA public key, and outputs the revocation number to the revocation number verification unit 435, if the sign is valid.

The revocation number verification unit 435 reads out the current revocation number from the revocation number storage unit 436, and stores, into the revocation number storage unit 436, the revocation number inputted from the signature verification unit 434 as a new revocation number, only when such inputted revocation number is larger than the current revocation number.

The revocation number storage unit 436 pre-stores “0” as the default revocation number, and stores the latest updated revocation number at the time, every time a revocation number is outputted from the revocation number verification unit 435.

The certificate serial number extraction unit 437 extracts the serial number from the inputted server certificate 75, and outputs it to the revocation judgment unit 438.

The revocation judgment unit 438 reads the revocation number from the revocation number storage unit 436, and compares it with the extracted serial number. When the extracted serial number is smaller than the revocation number, the revocation judgment unit 438 notifies the communication unit 420 that the server certificate 75 is revoked.

Next, a detailed description is given of each operation of the server certificate generation apparatus 10, the application servers 30a˜30k, and the terminals 40a˜40n.

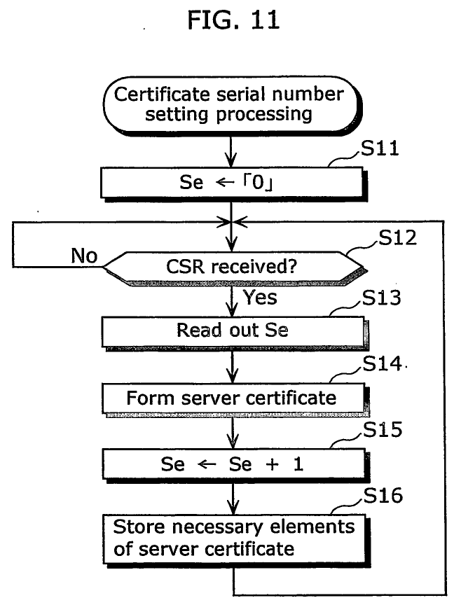

FIG. 11 is a flowchart showing the operation performed by the server certificate formation unit 107 when setting the serial number to a server certificate.

First, the server certificate formation unit 107 sets “0” as the default value of a serial number Se to be set to a server certificate 75 (S11), and waits for a CSR 70 to be received via the CSR receiving unit 106 (S12). Upon receipt of a CSR 70 (Yes in S12), the server certificate formation unit 107 reads out the serial number Se from the serial number storage unit 105 (S13), forms a server certificate 75 using the current time read out from the clock 104 and the CSR 70, and the like (S14), increments the serial number Se to be stored in the serial number storage unit 105 by “1”, after outputting the formed server certificate 75 to the signature unit 108 (S15), and stores, in the server certificate history table 110a, important elements of the server certificate 75, i.e. name, serial number, and validity period (S16). By repeating these processes (S12˜S16), server certificates 75 whose serial numbers increment monotonously are issued on a per-certificate basis.

Next, a description is given of certificate validity period management conducted by the server certificate validity period search unit 111.

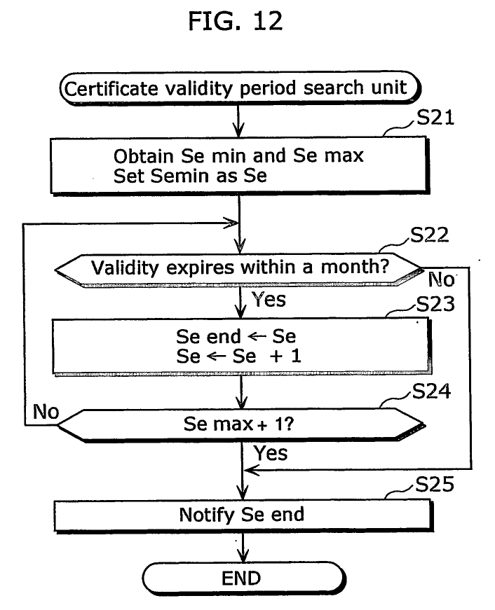

FIG. 12 is a flowchart showing the operation performed by the server certificate validity period search unit 111 when conducting certificate validity period management. Note that this processing is regularly carried out at predetermined time intervals.

The server certificate validity period search unit 111 first searches the server certificate history table 110a for the serial numbers, so as to obtain the smallest serial number Se min and the largest serial number Se max of all the serial numbers stored in the server certificate history table 110a, and sets, as the serial number Se, the serial number whose expiration data comes earlier than the other, i.e. the smallest serial number Se min (S21). Then, the server certificate validity period search unit 111 judges whether the validity of such serial number expires in a month or not (S22). When judging that the expiration date of such serial number comes in a month (Yes in S22), the server certificate validity period search unit 111 sets such serial number as the largest value Se end of all the serial numbers to be actually revoked, and increments the serial number Se by “1” in order to search for the validity period of the next record (S23). After incrementing the serial number Se, the server certificate validity period search unit 111 judges whether the coming of the validity periods of all the records in the server certificate history table 110a have been checked or not through to the serial number Se max of the last record (S24). When judging that the check has not yet been finished through to the last record (No in S24), the server certificate validity period search unit 111 carries out Steps S22˜S24 repeatedly, so as to obtain the largest serial number Se end of all the serial numbers to be actually revoked.

When judging that no serial number expires within a month (No in S22), or when the check has already been finished through to the last record (Yes in S24), the server certificate validity period search unit 111 notifies the revocation certificate search unit 113 of the largest value Se end of all the serial numbers to be actually revoked (S25).

By repeating the above processing, the serial numbers of server certificates 75 whose expiration dates are approaching are momentarily notified to the revocation certificate search unit 113.

Next, a description is given of processing performed by the revoked certificate search unit 113 when searching for a revoked certificate due to the coming of its validity period.

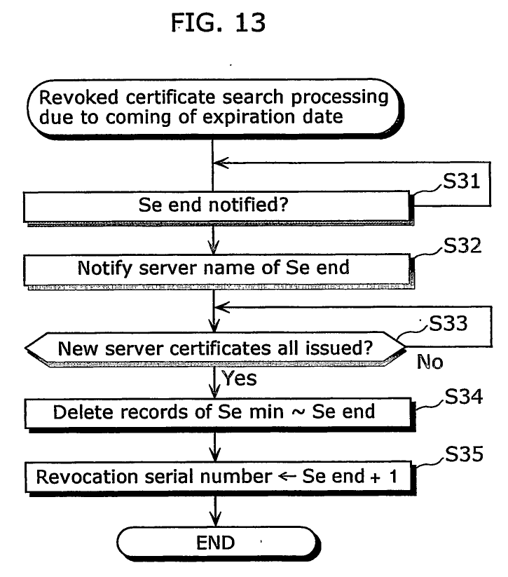

FIG. 13 is a flowchart showing the operation performed by the revoked certificate search unit 113 when searching for a revoked certificate due to the coming of its validity period.

The revoked certificate search unit 113 waits for the server certificate validity period search unit 111 to notify the largest value Seen of all the serial numbers to be actually revoked (S31). When notified of the largest value Seen of the serial numbers to be actually revoked (Yes in S31), the revoked certificate search unit 113 notifies the certificate revocation notification unit 114 of the server names corresponding to the serial numbers from the smallest serial number Se min through to the largest serial value Se end (S32). Accordingly, the certificate revocation notification unit 114 sends a revocation notification 80 to each of the corresponding application servers 30a˜30k. Then, each of the application servers 30a˜30k that has received the revocation notification 80 sends a CSR 70, as a result of which a new server certificate 75 that is assigned a serial number that increments monotonously, is to be issued for each of such application servers 30a˜30k.

Subsequently, the revoked certificate search unit 113 waits for all server certificates to be newly issued, each of which is assigned an incremented serial number (S33).

When all server certificates 75 have been issued (Yes in S33), the revoked certificate search unit 113 deletes all the records corresponding to the serial numbers Se min Se end (S34), and stores, in the revocation number storage unit 115, the value obtained by adding “1” to the largest value Seen of the serial numbers to be actually revoked as the revocation serial number (S32).

By repeating the above processing, server certificates 75 whose validities are close to expiring become subject to revocation one by one. Accordingly, the application servers 30a˜30k with such server certificates 75 to be revoked are required to renew their current server certificates to ones which are assigned incremented serial numbers.

Next, a description is given of processing performed by the revoked certificate search unit 113 when searching for a revoked certificate, in response to a revocation notification from the server certificate revocation notification unit 112.

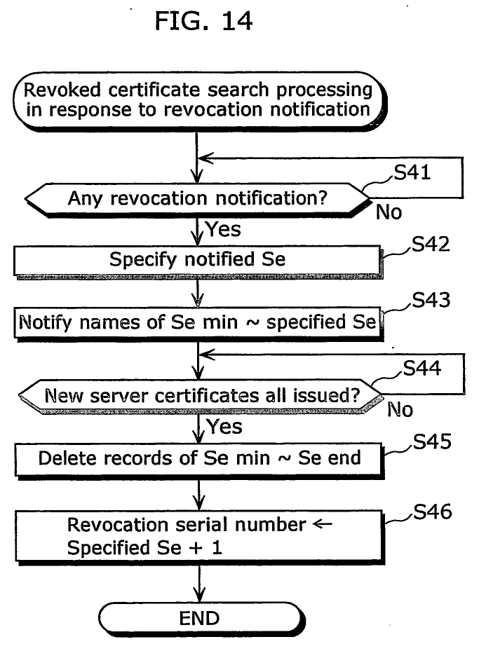

FIG. 14 is a flowchart showing the operation performed by the revoked certificate search unit 113 when searching for a revoked certificate, in response to a revocation notification. Note that such processing is carried out regularly at predetermined time intervals.

The revoked certificate search unit 113 waits for a revocation notification to be sent from the server certificate revocation notification unit 112 (S41). Upon receipt of a revocation notification, the revoked certificate search unit 113 specifies the notified serial number Se (S42), and notifies the certificate revocation notification unit 114 of the server names corresponding to the serial numbers from the smallest serial number Se min to such specified serial number Se (S43). Accordingly, the certificate revocation notification unit 114 sends revocation information 80 to each of corresponding application servers 30a˜30k. Then, each of the application servers 30a˜30k which has received the revocation information 80 sends a CSR 70, so as to obtain a newly issued server certificate 75 which is assigned a serial number that increments monotonously.

Then, the revoked certificate search unit 113 waits for all server certificates to be newly issued (S44).

When all server certificates 75 have been issued (Yes in S44), the revoked certificate search unit 113 deletes all the records corresponding to the serial numbers from the serial number Se min through to the specified serial number Se (S45), and stores, in the revocation number storage unit 115, the value obtained by adding “1” to the specified serial number Se to be actually revoked, as the revocation serial number (S46).

By repeating the above processing, not only a server certificate 75 which is regarded as being a target of revocation, but also all server certificates 75 which are assigned the smaller serial numbers than that of such server certificate shall become subject to revocation. Accordingly, the application servers 30a˜30k with such server certificates 75 to be revoked are required to renew their current server certificates to ones which are assigned incremented serial numbers.

Next, a description is given of processing performed by the revocation information signature unit 116 when forming revocation information.

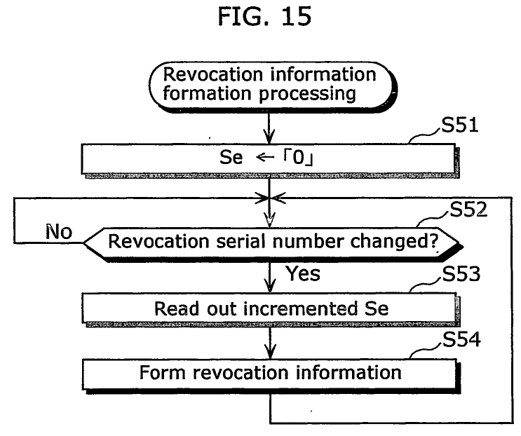

FIG. 15 is a flowchart showing the operation performed by the revocation information signature unit 116 when forming revocation information.

The revocation information signature unit 116 reads out the default value “0” of the revocation serial number Se from the revocation number storage unit 115 and sets it (S51). Then, the revocation information signature unit 116 forms revocation information 90 by putting together such revocation serial number Se, a pre-stored issuer, and a signature created by use of the CA private key read out from the CA private key storage unit 103, and outputs the formed revocation information 90 to the revocation information notification unit 117.

Then, the revocation information signature unit 116 monitors the revocation number storage unit 115 so as to wait for the revocation serial number to change (S52). Here, all server certificates 75 with the serial numbers that are equal to or smaller than the value obtained by subtracting “1” from the revocation serial number are regarded as being subject to revocation. Thus, what should be actually carried out in Step S52 is simply a judgment on whether the value of the revocation serial number has incremented or not. When the revocation serial number is incremented, the revocation information signature unit 116 reads out the incremented revocation serial number Se from the revocation number storage unit 115 (S53), forms revocation information 90 by putting together such revocation serial number Se, a pre-stored issuer, and a signature created by use of the CA private key read out from the CA private key storage unit 103 (S54), and outputs the formed revocation information 90 to the revocation information notification unit 117.

By repeating the above processing, revocation information 90 whose revocation serial number increments when necessary is sequentially stored into the revocation information storage unit 201 of the repository 20.

Next, a description is given of processing performed by the server certificate verification unit 430 of each of the terminals 40a˜40n, when obtaining revocation information.

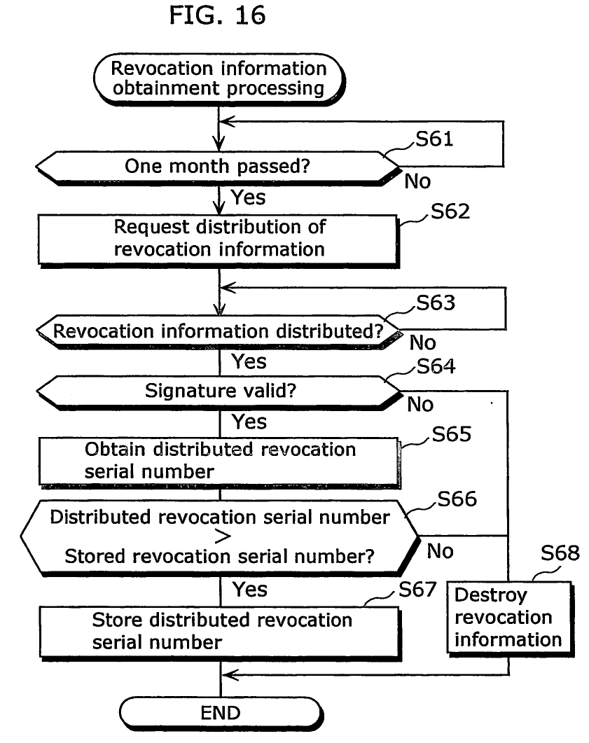

FIG. 16 is a flowchart showing the operation performed by each unit in the server certificate verification unit 430 when obtaining revocation information. Note that such processing is carried out regularly at predetermined time intervals (once a month).

First, the revocation information request unit 431 of each of the terminals 40a˜40n obtains the revocation information 90 from the repository 20 regularly (once a month), and stores the revocation number. More specifically, the revocation information request unit 431 waits for a month to pass according to the internal timer (S61). When a month has passed (Yes in S61), the revocation information request unit 431 requests the repository 20 to distribute revocation information 90 (S62), and waits for the revocation information 90 to be distributed (S63).

When this is done, if the revocation number of the obtained revocation information 90 is false, it is possible that an authorized application server will be verified as being an unauthorized application server, and vice versa. Therefore, the following check shall be conducted.

Upon receipt of the revocation information 90 (Yes in S62), the signature verification unit 434 first verifies whether the signature on such revocation information 90 is valid or not (S64). Since only the server certificate generation apparatus 10 is allowed to sign revocation information 90, the signature verification unit 434 regards that the revocation information 90 is authorized data if its signature is valid.

Next, it is checked whether the revocation number is a larger number than the currently stored revocation number. More specifically, the revocation number verification unit 435 obtains the distributed revocation serial number (S65), so as to judge whether the value of such distributed revocation serial number is larger than the value of the revocation serial number stored by the revocation number storage unit 436 (S66). A revocation number is monotonously incremented at every revocation of a server certificate 75, and therefore a revocation number never decreases.

Thus, when the revocation number of the received revocation information 90 is larger than the current revocation number (Yes in S66), the distributed revocation serial number shall be stored (S67). On the other hand, when the revocation number of the received revocation information 90 is smaller than the current revocation number (No in S66), the received revocation information shall be destroyed, being regarded that such revocation number is false or that there was some mistake (S68).

By repeating the above processing, it becomes possible for the server certificate verification unit 430 to store only an authorized revocation number that increments monotonously.

Next, a description is given of the case where a communication is carried out the terminals 40a˜40n and the application servers 30a˜30k in encrypted form between.

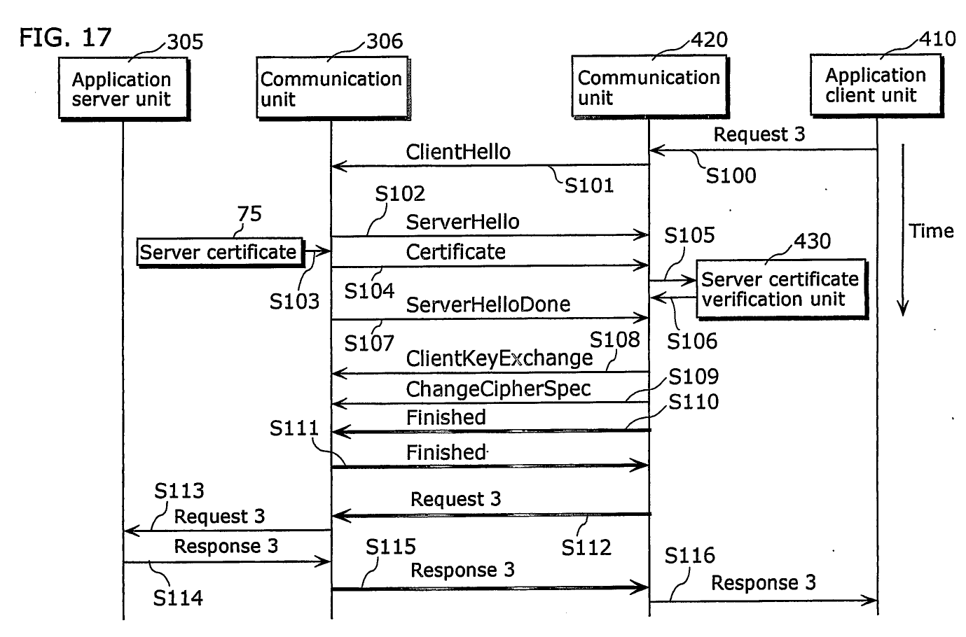

FIG. 17 is a sequence diagram showing the case where an encrypted communication is carried out. Note that a description is given here of the case where a communication is carried out between the terminal 40a and the application server 30a.

In the terminal 40a, the application client unit 410 indicates the communication unit 420 to send a request 3 to the application server 30a in encrypted form (S100). Then, the communication unit 420 sends, to the communication unit 306 of the application server 30a, a ClientHello packet that includes a client random number and a type of encryption that the communication unit 420 can support, so as to start an SSL handshake (S101).

In the application server 30a, the communication unit 306 determines the type of the encryption from the ClientHello packet, and sends such determined encryption type together with the server random number and the session ID in a ServerHello packet (S102). Then, the communication unit 306 reads the server certificate 75 from the server certificate storage unit 304 (S103), sends such server certificate 75 as a Certificate packet to the communication unit 420 of the application server 30a (S104), and further sends a ServerHelloDone packet to the communication unit 420 (S107).

The communication unit 420 of the terminal 40a reads the server certificate 75 from the Certificate packet, and sends it to the server certificate verification unit 430 (S105). The server certificate verification unit 430 verifies if such server certificate 75 is invalid or not, and notifies the communication unit 306 of the verification result (S106). If the server certificate 75 is invalid, the communication unit 420 sends an alert packet to the communication unit 306 to disconnect the session, and returns an error to the application client unit 410. Meanwhile, when the server certificate 75 is valid, the communication unit 420 generates a premaster secret used to calculate a common key for encryption, encrypts such premaster secret with the server public key contained in the server certificate 75, sends, to the communication unit 306, a ClientKeyExchange packet that includes the encrypted premaster secret, after the arrival of the ServerHelloDone packet (S108), and further sends a ChangeCipherSpec packet to the communication unit 306 (S109). ChangeCipherSpec packet is a packet indicating the initiation of encryption. The communication unit 420 generates a common key A used for encryption from the client random number, the server random number, and the premaster secret, and encrypts a Finished packet indicating the completion of the handshake with the generated common key A, so as to send such encrypted packet to the communication unit 306 of the application server 30a (S110).

The communication unit 306 of the application server 30a reads the encrypted premaster secret from the ClientKeyExchange packet so as to decrypt it into the premaster secret with the server private key, and generates a common key B used for encryption from the premaster secret, the server random number and the client random number. When an SSL handshake has been normally conducted, the common key A possessed by the communication unit 306 and the common key B possessed by the communication unit 420 become the same. The communication unit 306 decrypts the received Finished packet with the common key B, and when such decryption succeeds, encrypts such Finished packet to send it to the communication unit 420 (S111). The subsequent communication after this Finished packet shall be carried out in encrypted form.

The communication unit 420 of the terminal 40a decrypts the received Finished packet, and sends a request 3 in encrypted form to the communication unit 306 of the application server 30a, when such decryption succeeds (S112).

The communication unit 306 of the application server 30a decrypts the request 3, and sends the decrypted request 3 to the application server unit 305 (S113). The application server unit 305 processes such request 3 to generate a response 3, and indicates the communication unit 306 to send it to the terminal 40a (S114). Then, the communication unit 306 sends the response 3 to the communication unit 420 of the terminal 40a in encrypted form (S115).

The communication unit 420 of the terminal 40a decrypts the encrypted response 3, and outputs the decrypted response 3 to the application client unit 410 (S116).

The communication is carried out in encrypted form in the above manner.

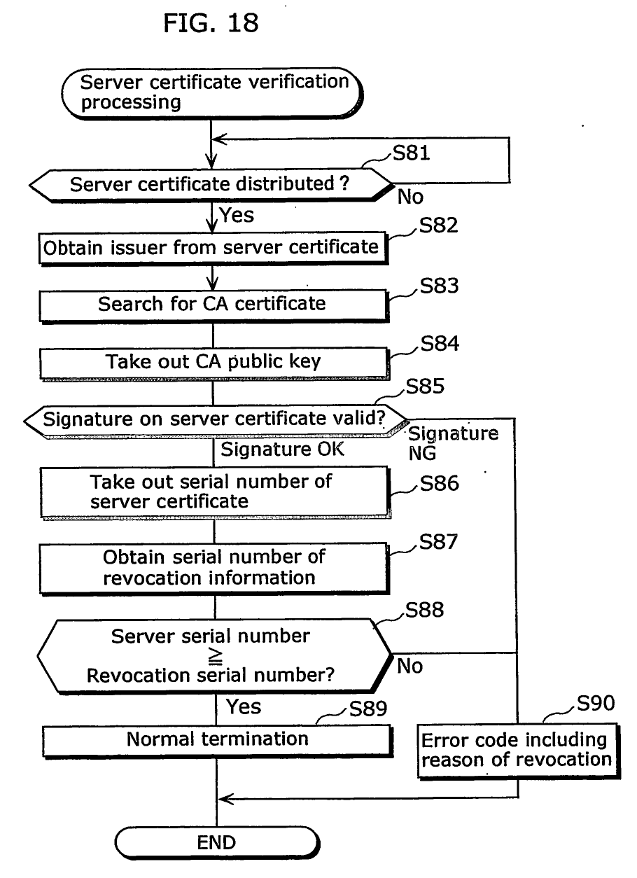

FIG. 18 is a flowchart showing the operation performed by the server certificate verification unit 430 when verifying a server certificate 75.

After obtaining the server certificate 75, the signature verification unit 432 of the server certificate verification unit 430, reads the issuer from such obtained server certificate 75, and searches the CA certificate storage unit 433 for the CA certificate 60 of such issuer. Then, the signature verification unit 432 reads the CA public key from the searched out CA certificate 60, and checks the signature on the server certificate 75 using such CA public key. More specifically, the signature verification unit 432 waits for a server certificate 75 to be distributed (S81), and when it is distributed (Yes in S81), obtains the issuer from such server certificate 75 (S82), and searches the CA certificate storage unit 433 for the same issuer's CA certificate 60 (S83). Then, the signature verification unit 432 reads the CA public key from the searched out CA certificate 60 (S84), and judges whether the signature on the server certificate 75 is valid or not by decrypting it with the CA public key (S85).

When the signature of the server certificate 75 is judged to be invalid (Signature NG in S85), the signature verification unit 432 notifies the communication unit 420 of an error code indicating signature verification error (S90), and ends the verification. When the signature is judged to be valid (Signature OK in S85), on the other hand, the certificate serial number extraction unit 437 reads the serial number (server serial number) from such server certificate 75 (S86). Then, the revocation judgment unit 438 reads the revocation number from the revocation number storage unit 436, and compares it with the serial number read out by the certificate serial number extraction unit 437, that is, judges the relationship between the server serial number and the revocation serial number in terms of their sizes (S88).

When the serial number is smaller than the revocation number (No in S88), the revocation judgment unit 438 judges that the server certificate 75 is already revoked, and notifies the communication unit 420 of an error code indicating revocation (S90), so as to end the verification. Meanwhile, when the serial number is larger than or equal to the revocation number (Yes in S88), the revocation judgment unit 438 judges that such server certificate 75 is valid, and notifies the communication unit 420 that the verification has ended normally.

Through the above processing, a server certificate 75 is authenticated only when the application server 30a sends a server certificate 75 that includes a valid signature and the serial number that is equal to or larger than the revocation number.

Next, a description is given of the relationship between server certificates 75 generated by the server certificate generation apparatus 10 and the revocation number.

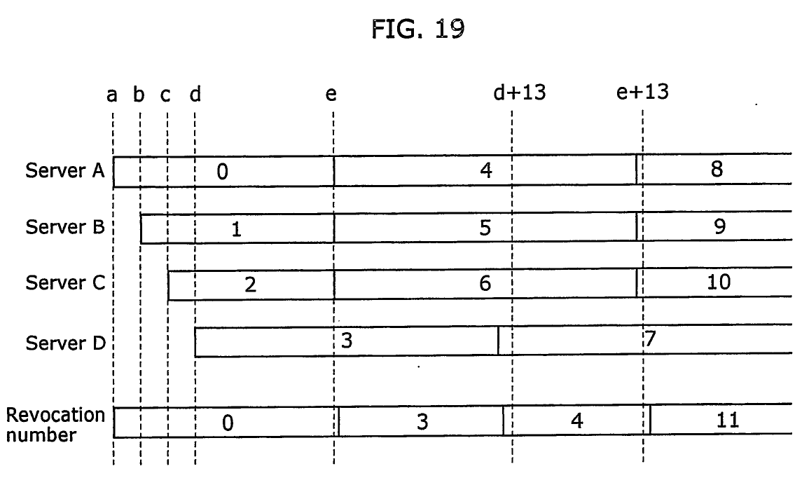

FIG. 19 is a diagram showing the relationship between serial numbers of server certificates 75 and the revocation number, when there are four servers.

For description purposes, suppose here that such servers are A, B, C, and D, each being installed at the time “a”. “b”, “c”, and “d” respectively and that the serial numbers of server certificates 75 possessed by the respective servers are “0”, “1”, “2”, and “3”.

When a concern arises at the time “e”, regarding the security of the server certificate 75 of the server C, the following information is stored in the server certificate history storage unit 110 at that point of time:

| Server name | Serial | Validity period |
|---|---|---|
| A | 0 | a + 13 (months) |
| B | 1 | b + 13 (months) |
| C | 2 | c + 13 (months) |
| D | 3 | d + 13 (months) |

Therefore, the revocation certificate search unit 113 of the server certificate generation apparatus 10 searches for server certificates 75 with serial numbers smaller than “2”, which is the serial number of the server certificate 75 possessed by the server C. As a result, the server certificates 75 of the server A and the server B are searched out. Accordingly, the certificate revocation notification unit 114 of the server certificate generation apparatus 10 requests the servers A, B, and C to renew their server certificates 75 (gives notification that their server certificates 75 will be revoked). As a result, each of the servers A, B, and C makes a request to generate a new server certificate 75, and new server certificates 75 which are respectively assigned the serial numbers of “4”, “5”, and “6” are newly generated, so as to be sent to the respective application servers A, B, and C. The validity period of each server certificate 75 generated here shall be “e+13 months”. Accordingly, the data stored in the server certificate history information storage unit 110 shall be updated as follows:

| Server name | Serial | Validity period |
|---|---|---|
| D | 3 | d + 13 (months) |
| A | 4 | e + 13 (months) |
| B | 5 | e + 13 (months) |
| C | 6 | e + 13 (months) |

After the server certificate 75 of each server is renewed, the revocation number storage unit 115 of the server certificate generation apparatus 10 changes the revocation number to the serial number “3” which is valid and smallest at that point of time, and has the revocation information storage unit 201 of the repository 20 to store revocation information 90 that includes such serial number. Stated another way, such new revocation number “3” is obtained by adding “1” to the serial number “2” of the original server certificate 75 possessed by the server C which was the cause of the revocation.

Each of the terminals 40a˜40n regularly obtains and stores a revocation number from the repository 20. When this is done, if false revocation number is stored, it is possible that an authorized server will be verified as being an unauthorized server, and vice versa. Therefore, the following check shall be conducted. First, the signature on the revocation information is checked. Since only the CA is allowed to sign revocation information, revocation information is regarded as being authorized data if its signature is valid. Next, it is checked if the revocation number is larger than the currently stored revocation number. A revocation number increments due to revocation of a server certificate, but never decreases. Therefore, when the revocation number is smaller than the current revocation number, such revocation number shall be destroyed, being regarded that such revocation number is false or that there was some mistake.

Meanwhile, when there occurs server spoofing by use of the server certificate 75 of the server C, the serial number of the server certificate 75 of the spoofed server is “2”. However, since the revocation number at that point of time is “3”, there is no possibility that such spoofed server will be trusted, according to the rule stipulating that any server certificates 75 with the serial numbers smaller than the revocation number shall be revoked.

Furthermore, the server certificate validity period search unit 111 always checks the server certificate history storage unit 110, so as to search for server certificates 75 whose validities expire within a month from the current time. For example, when d+12 months have passed, the validity period of the server certificate 75 possessed by the server D will expire in a month. Thus, the server certificate validity period search unit 111 notifies the revoked certificate search unit 113 of the serial number “3” of the server certificate 75 possessed by the server D, and the certificate revocation notification unit 114 requests the server D to renew its server certificate 75. Moreover, when there exits a server with a server certificate 75 that is assigned a smaller serial number than that of the server certificate 75 possessed by the server D, the certificate revocation notification unit 114 also requests such server to renew its server certificate 75. After these server certificates 75 are renewed, the revocation number is updated to “4”, which is obtained by adding “1” to the serial number of the server certificate 75 possessed by the server D.

As described above, when renewing a server certificate 75 whose validity period is approaching, all server certificates 75 with serial numbers smaller than the serial number of such server certificate 75 whose validity period is approaching shall be renewed and the value obtained by adding “1” to the serial number of the server certificate 75′ whose expiration date is approaching shall be set as a new revocation number. Accordingly, even when there occurs server spoofing by use of an expired server certificate 75, it becomes possible, even for a device which does not have a clock and therefore is incapable of obtaining a precise time, to confirm that such server certificate 75 is revoked, based on the revocation number.

Note that the updated serial numbers are assigned to the servers A, B, and C in order of “4”, “5”, and “6” in the present embodiment, but the present invention is not limited to this order.

Also, in the first embodiment, the default serial number is “0”, which is incremented by “1” every time a new server certificate 75 is issued, but the default serial number may be set freely and a different value may be incremented for every issue of server certificates, as long as such value increments monotonously.

Furthermore, in the first embodiment, “0” is used as the default revocation number, but the default revocation number may be any other value as long as such value is equal to or smaller than the default serial number. In other words, when the default serial number of a server certificate 75 is set as “1”, for example, the default revocation number may be either “0” or “1”.

Moreover, since a server certificate 75 to be issued is assigned a serial number which increments monotonously, with the default serial number of a server certificate 75 being set to a value equal to or larger than the default revocation number, it is possible to enjoy the functionality equivalent to the one to be achieved when the revocation serial number is referred to, which is why the revocation number is not used as a reference in the present embodiment. However, the revocation number may be actually refereed to, so as to issue a server certificate 75 with a serial number that is equal to or larger than such revocation number.

As described above, according to the first embodiment, a revocation notification is given to an application server with a server certificate which is about to expire, and a new server certificate is issued for such application server, so as to make its original server certificate unusable by revoking it. Accordingly, it is not necessary for each of the terminals 40a˜40n to check the validity period of a server certificate, or to be equipped with a precise clock. What is more, since only one revocation serial number is included in revocation information 90, and each of the terminals 40a˜40n stores such revocation information 90 so as to check the validity of a server certificate 75 based on the relationship between the serial number of such server certificate 75 and the revocation number in terms of their sizes, the terminals 40a˜40n are not required to have resources as in the conventional cases. Accordingly, only a small amount of resources are required, meaning that the present invention is applicable to networked appliances, and the like.

### Second Embodiment

The following describes a communication system according to the second embodiment of the present invention.

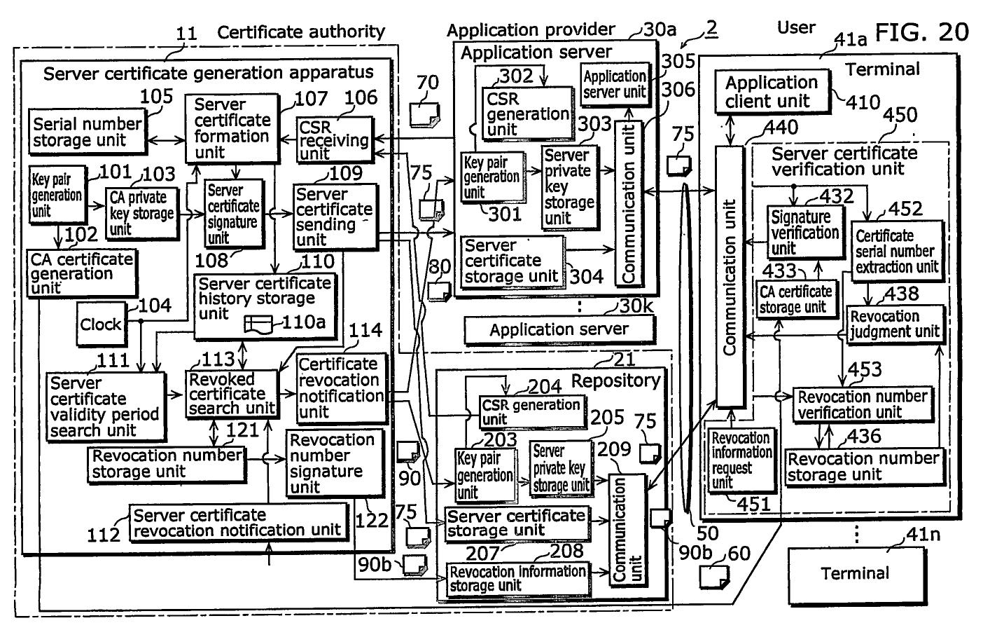

FIG. 20 is a block diagram showing an overall configuration of a communication system 2 according to the second embodiment of the present invention. Note that components that are the same as those of the communication system 1 shown in FIG. 7 are assigned the same numbers, and descriptions thereof are omitted.

Such communication system 2 is comprised of a server certificate generation apparatus 11 and a repository 21 which are used by a certificate authority, a plurality of application servers 30a˜30k used by providers of applications such as video content, a plurality of terminals 41a˜41n used by users, and the Internet 50 that connects the repository 21, the application servers 30a˜30k and the terminals 41a˜41n with each other, as in the case of the communication system 1 according to the first embodiment.

In the communication system 1 according to the first embodiment, the server certificate generation apparatus 10 sends revocation information 90 to the repository 20, which then sends the revocation information 90 to each of the terminals 40a˜40n. However, the communication system 2 according to the second embodiment is greatly different from the communication system 1 in that the server certificate generation apparatus 11 sends, to the repository 21, revocation information 90b composed only of the revocation number.

Moreover, in the communication system 1, the repository 20 sends revocation information 90 to each of the terminals 40a˜40n in unencrypted form, and each of such terminals 40a˜40n checks whether the received revocation information 90 is invalid or not based on the signature on such revocation information 90. However, the communication system 2 is greatly different from the first embodiment in that the server certificate generation apparatus 11 issues server certificates 75 to the repository 21, which then sends such server certificates 75 to the terminals 41a˜41n at their requests of revocation number distribution, as in the case of the application servers 30a˜30k. Then, each of the terminals 41a˜41n performs server authentication on such repository 21, and the repository 21 distributes the revocation number in encrypted form after sharing an SSL session key with each of the terminals 41a˜41n.

Such being the case, the server certificate generation apparatus 11, as in the case of the application servers 30a˜30k, is comprised of the key pair generation unit 101, the CA certificate generation unit 102, the CA private key storage unit 103, the clock 104, the serial number storage unit 105, the CSR receiving unit 106, the server certificate formation unit 107, the signature unit 108, the server certificate sending unit 109, the server certificate history storage unit 110, the server certificate validity period search unit 111, the server certificate revocation notification unit 112, the revoked certificate search unit 113, and the certificate revocation notification unit 114, so that the server certificate generation apparatus 11 accepts a CSR 70 sent from the repository 21, issues a server certificate 75 to the repository 21, and sends a revocation notification 80 to the repository 21 when such server certificate 75 becomes subject to revocation. Moreover, the server certificate generation apparatus 11 does not include the revocation information signature unit 116 equipped to the server certificate generation apparatus 10, but is further equipped with a revocation number storage unit 121 and a revocation number notification unit 122 instead of the revocation number storage unit 115 and the revocation information notification unit 117, in addition to the above components. The revocation number storage unit 121, as in the case of the revocation number storage unit 115, stores, as the revocation number, a revocation number which is the smallest valid serial number of all the serial numbers of server certificates 75 issued by the server certificate sending unit 109. Note that the default revocation number is “0”. The revocation number stored in the revocation number storage unit 121 is sent to the revocation number notification unit 122. The revocation number notification unit 122 notifies the repository 21 only of the revocation number that includes no signature and is stored in the revocation number storage unit 121, as revocation information 90b.

The repository 21 is made up of a key pair generation unit 203, a CSR generation unit 204, a server private key storage unit 205, a server certificate storage unit 207, a revocation information storage unit 208, and a communication unit 209.

The repository 21 communicates with the terminals 41a˜41n using SSL, as in the case of the application servers 30a˜30k. For this reason, the key pair generation unit 203 generates a new server public key and a new server private key every time a server is installed and a revocation notification 80 is received from the server certificate generation apparatus 11. A server public key is sent to the CSR generation unit 204, and a server private key is stored into the server private key storage unit 205.

The CSR generation unit 204 generates a CSR 70 from the server public key and a pre-stored server name, and sends the generated CSR 70 to the server certificate generation apparatus 11. Subsequently, the server certificate generation apparatus 11 generates a server certificate 75 from the received CSR 70, and sends such generated server certificate 75 to the repository 21. The server certificate storage unit 207 stores a new server certificate 75 every time it receives such new server certificate 75.

The revocation information storage unit 208 stores a new revocation number every time it receives revocation information 90b composed only of the revocation number from the server certificate generation apparatus 11.

The communication unit 209 is an interface for communicating with the terminals 41a˜41n via the Internet 50 according to the above-described protocol for encryption, and the like. More specifically, the communication unit 209 reads a server certificate 75 from the server certificate storage unit 207 in order to perform server authentication, when receiving a request from each of the terminals 41a˜41n for starting a communication, and sends the read-out server certificate 75 to each of the terminals 41a˜41n. Moreover, the communication unit 209 decrypts, with the server private key stored in the server private key storage unit 205, an encryption type received from each of the terminals 41a˜41n, so as to generate a common key used for an encrypted communication. Subsequently, when there is a request for the revocation number from any of the terminals 41a˜41n in an encrypted communication, the communication unit 209 reads the revocation information 90b from the revocation information storage unit 208, and outputs such revocation information 90b in encrypted form to the terminal that has made the request. Meanwhile, when receiving a request in an unencrypted communication, the communication unit 209 disconnects the communication.

Each of the terminals 41a˜41n is made up of the application client unit 410, a communication unit 440 instead of the communication unit 420, and a server certificate verification unit 450 instead of the server certificate verification unit 430. The server certificate verification unit 450 is made up of the signature verification unit 432, the CA certificate storage unit 433, the revocation number storage unit 436, and the revocation judgment unit 438, as in the case of the server certificate verification unit 430, and further includes a revocation information request unit 451 in stead of the revocation information request unit 431, a certificate serial number extraction unit 452 instead of the certificate serial number extraction unit 437, and a revocation number verification unit 453 instead of the revocation number verification unit 435.

The revocation information request unit 451 of each of the terminals 41a˜41n regularly (e.g. once a month) requests the communication unit 440 to obtain the revocation number from the repository 21.

The signature verification unit 432 reads the CA certificate 60 from the CA certificate storage unit 433, so as to verify the signature on a server certificate 75, and notifies the communication unit 440 of abnormality, if such signature is abnormal.

The certificate serial number extraction unit 452 extracts the serial number from the inputted server certificate 75, and outputs the extracted serial number to the revocation judgment unit 438 and the revocation number verification unit 453.

The revocation number verification unit 453 reads out the revocation number stored in the revocation number storage unit 436, so as to compare it with the serial number (revocation number) obtained from the repository 21, as well as comparing the read-out revocation number with the serial number outputted from the certificate serial number extraction unit 452. Then, when the serial number obtained from the repository 21 is smaller than the revocation number stored in the revocation number storage unit 436, the revocation number verification unit 453 notifies the communication unit 440 of the fact that there is an abnormality due to some cause. Furthermore, when the serial number of a server certificate 75 extracted from the application servers 30a˜30k or the repository 21 is smaller than the revocation number, the revocation number verification unit 453 notifies the communication unit 440 that such server certificate 75 is already revoked.

The communication unit 440 is an interface for communicating with the application servers 30a˜30k and the repository 21 via the Internet 50 according to the above-described protocol for encrypted or unencrypted communication. In addition to communicating with the application servers 30a˜30k, as in the case of the communication unit 420, the communication unit 440 (1) analyzes a command sent from the repository 21, (2) requests the server certificate verification unit 430 for processing, according to the result of such analysis, (3) sends data passed from the application client unit 410 and the server certificate verification unit 450 to the depository 21, and (4) receives a server certificate 75 and revocation information 90b from the repository 21. In other words, the communication unit 440 receives revocation information 90b in an encrypted communication, using the communication protocol shown in FIG. 17.

More specifically, at a request for revocation information 90b from the revocation information request unit 451, the communication unit 440 requests the communication unit 209 of the repository 21 to start an encrypted communication. As a result, the communication unit 440 receives a server certificate 75 from the communication unit 209 of the repository 21.

Then, the communication unit 440 outputs the received server certificate 75 to the signature verification unit 432 and the certificate serial number extraction unit 452. When notified of abnormality of such server certificate 75 from the signature verification unit 432, the communication unit 440 notifies the communication unit 209 in the repository 21 of such abnormality of the server certificate 75, so as to disconnect the session.

Meanwhile, when the signature on the server certificate 75 is normal or such server certificate 75 is not revoked, the communication unit 440 generates a premaster secret, encrypts such premaster secret with the server public key contained in the server certificate 75, and sends the encrypted premaster secret to the communication unit 209 of the repository 21. Furthermore, the communication unit 440 generates an encryption key used for an encrypted communication using data obtained so far, so as to carry out the subsequent communication in encrypted form using such encryption key. Stated another way, the communication unit 440 sends a request for revocation number to the repository 21 in encrypted form. Then, upon receipt of encrypted revocation information 90b (revocation number) from the repository 21, the communication unit 440 decrypts the received encrypted revocation number, and outputs the decrypted revocation number to the revocation number verification unit 453.

The revocation number verification unit 453 reads out the current revocation number from the revocation number storage unit 436, and compares it with the revocation number notified from the repository 21. When this is done, if the notified revocation number is smaller than the current revocation number, such notified revocation number is judged to be invalid, and this processing is terminated. This is because a revocation number is monotonously incremented, and therefore a revocation number is never replaced with a revocation number smaller than the current revocation number. Meanwhile, when the notified revocation number equals to the current revocation number, the processing is terminated, judging that there was no change of revocation numbers. Furthermore, when the notified revocation number is larger than the current revocation number, the revocation number verification unit 453 compares such notified revocation number with the serial number of the repository 21 inputted from the certificate serial number extraction unit 452. When the notified revocation number is smaller than the serial number of the repository 21, the revocation number verification unit 453 judges that the notified revocation number is invalid, and terminates the processing. This is because if such notified revocation number were valid, it means that the serial number of the repository 21 is invalid, that is, the server certificate 75 is revoked, and therefore that the revocation number obtained from the repository 21 with such invalid server certificate 75 is not trustworthy. Therefore, when the notified revocation number is equal to or larger than the serial number of the repository 21, the revocation number verification unit 453 stores such notified revocation number into the revocation number storage unit 436 as a new revocation number.

Meanwhile, attacks to the revocation number includes: making valid a server certificate 75 which became revoked in the past, by fraudulently setting a smaller value as the revocation number; and setting a larger value as the revocation number so as to cause overflow. It is against these attacks that the revocation number is subject to a validity check in the above-described manner.

With the above structure, it becomes possible to store only a valid revocation number, without needing to check the signature of obtained revocation information 90b.

Note that the following structure is also conceivable as another embodiment of the present invention.

The certificate issuing apparatus comprising: a revocation number storage unit operable to store a revocation number; a server certificate information storage unit operable to store the following information concerning each of server certificates issued in the past: an identification number, a validity period, and a subject to which said server certificate was issued; and a certificate issuing unit operable to issue a new server certificate, wherein the certificate issuing unit issues a new server certificate which is assigned an identification number equal to or larger than the revocation number stored by the revocation number storage unit.

Furthermore, when revoking a server certificate, said server certificate issuing apparatus (1) obtains the identification number of said server certificate, (2) determines, as a new revocation number, a number which is larger than said identification number, (3) stores said new revocation number into the revocation number storage unit, (4) searches the server certificate information storage unit so as to read out a server certificate (hereinafter referred to as “a server certificate to be renewed”) whose identification number is equal to or smaller than the identification number of the server certificate, and (5) issues, to a server which possesses said server certificate to be renewed, a new server certificate whose identification number is equal to or larger than the new revocation number.

Moreover, said server certificate issuing apparatus (1) searches the server certificate information storage unit for a server certificate whose validity period is approaching, so as to obtain the identification number of said server certificate, (2) determines, as a new revocation number, a number which is larger than said identification number, (3) stores said new revocation number into the revocation number storage unit, (4) searches the server certificate information storage unit so as to read out a server certificate (hereinafter referred to as “a server certificate to be renewed”) whose identification number is equal to or smaller than the identification number of the server certificate, and (5) issues, to a server which possesses said server certificate to be renewed, a new server certificate whose identification number is equal to or larger than the new revocation number.

### INDUSTRIAL APPLICABILITY

The communication apparatus, the certificate issuing apparatus, and the communication system according to the present invention provide the effect of checking spoofing and the like by use of a small amount of resources, and are suited for use as networked appliances such as video decoder as well as computer apparatuses capable of server authentication such as mobile phone and personal digital assistant.

1. A communication apparatus for communicating with a server apparatus based on a server certificate that indicates validity of said server apparatus, comprising:
a revocation number obtainment unit operable to obtain a revocation number from a repository apparatus storing said revocation number that is information serving as a criterion for judging validity of the server certificate;
a revocation number storage unit operable to store the obtained revocation number;
an identification number reading unit operable to read out, from the server certificate, an identification number used to identify said server certificate;
a certificate judgment unit operable to judge the validity of the server certificate by comparing the read-out identification number with the revocation number stored by the revocation number storage unit; and
a communication control unit operable to establish a communication with the server apparatus when the server certificate is judged to be valid, and operable not to establish a communication with the server apparatus when the server certificate is judged to be invalid.

2. The communication apparatus according to claim 1,
wherein the certificate judgment unit judges that the server certificate is valid, when the identification number is equal to or larger than the revocation number.

3. The communication apparatus according to claim 1, further comprising a revocation number judgment unit operable to judge validity of the revocation number,
wherein the certificate judgment unit judges the validity of the server certificate by use of the revocation number, when the revocation number judgment unit judges that the revocation number is valid.

4. The communication apparatus according to claim 3,
wherein the revocation number judgment unit judges the validity of the revocation number by comparing an identification number of a repository certificate indicating validity of the repository apparatus with the revocation number stored by the revocation number storage unit.

5. The communication apparatus according to claim 4,
wherein the revocation number judgment unit judges that the repository apparatus is valid, when the identification number of the repository certificate is equal to or larger than the revocation number stored by the revocation number storage unit.

6. The communication apparatus according to claim 3,
wherein the revocation number judgment unit judges the validity of the revocation number obtained by the revocation number obtainment unit by comparing said revocation number obtained by the revocation number obtainment unit with the revocation number stored by the revocation number storage unit.

7. The communication apparatus according to claim 6,
wherein the revocation number judgment unit judges that the revocation number obtained by the revocation number obtainment unit is valid, when said obtained revocation number is equal to or larger than the revocation number stored by the revocation number storage unit.

8. A certificate issuing apparatus for issuing a server certificate indicating validity of a server apparatus, comprising:
a revocation number storage unit operable to store a revocation number that is information serving as a criterion for judging validity of the server certificate; and
an issuing unit operable to issue a new server certificate,
wherein the issuing unit issues the new server certificate that includes an identification number indicating a value which is equal to or larger than the revocation number stored by the revocation number storage unit.

9. The certificate issuing apparatus according to claim 8, further comprising a revocation number update unit operable to update the revocation number stored by the revocation number storage unit to a number larger than an identification number of a server certificate to be revoked, when notified of said identification number of the server certificate to be revoked.

10. The certificate issuing apparatus according to claim 9,
wherein the issuing unit issues the new server certificate for a server apparatus with a server certificate that is assigned an identification number smaller than the updated revocation number, in the case where the revocation number update unit updates the revocation number stored by the revocation number storage unit.

11. The certificate issuing apparatus according to claim 8, further comprising a revocation number update unit operable to specify an identification number of a server certificate, an expiration date of which is approaching, and update the revocation number stored by the revocation number storage unit to a number larger than said identification number.

12. The certificate issuing apparatus according to claim 11,
wherein the issuing unit issues the new server certificate for a server apparatus with a server certificate that is assigned an identification number smaller than the updated revocation number, in the case where the revocation number update unit updates the revocation number stored by the revocation number storage unit.

13. A communication system comprising a server apparatus, a certificate issuing apparatus for issuing a server certificate indicating validity of the server apparatus, and a communication apparatus for communicating with the server apparatus based on said server certificate,
wherein the certificate issuing apparatus includes:
a first revocation number storage unit operable to store a revocation number that is information serving as a criterion for judging validity of the server certificate; and
an issuing unit operable to issue a new server certificate,
wherein the issuing unit issues the new server certificate that includes an identification number indicating a value which is equal to or larger than the revocation number stored by the first revocation number storage unit, and
the communication apparatus includes:
a revocation number obtainment unit operable to obtain a revocation number from a repository apparatus storing said revocation number that is information serving as a criterion for judging the validity of the server certificate;
a second revocation number storage unit operable to store the obtained revocation number;
an identification number reading unit operable to read out, from the server certificate, an identification number used to identify said server certificate;
a certificate judgment unit operable to judge the validity of the server certificate by comparing the read-out identification number with the revocation number stored by the second revocation number storage unit; and
a communication control unit operable to establish a communication with the server apparatus when the server certificate is judged to be valid, and operable not to establish a communication with the server apparatus when the server certificate is judged to be invalid.

14. A communication method for carrying out a communication with a server apparatus based on a server certificate indicating validity of said server apparatus, comprising:
a revocation number obtainment step of obtaining a revocation number from a repository apparatus storing said revocation number that is information serving as a criterion for judging validity of the server certificate;
a revocation number storage step of storing the obtained revocation number into a recording unit;
an identification number reading step of reading out, from the server certificate, an identification number used to identify said server certificate;
a certificate judgment step of judging the validity of the server certificate by comparing the read-out identification number with the revocation number stored by the recording unit; and
a communication control step of establishing a communication with the server apparatus when the server certificate is judged to be valid, and of not establishing a communication with the server apparatus when the server certificate is judged to be invalid.

15. A certificate issuing method for issuing a server certificate indicating validity of a server apparatus, comprising:
a revocation number storage step of storing, into a recording unit, a revocation number that is information serving as a criterion for judging validity of the server certificate; and
an issuing step of issuing a new server certificate,
wherein in the issuing step, the new server certificate that includes an identification number is issued, the identification number indicating a value which is equal to or larger than the revocation number stored by the recording unit.

16. A program for a communication apparatus that communicates with a server apparatus based on a server certificate indicating validity of said server apparatus, the program causing a computer to execute the following steps:
a revocation number obtainment step of obtaining a revocation number from a repository apparatus storing said revocation number that is information serving as a criterion for judging validity of the server certificate;
a revocation number storage step of storing the obtained revocation number into a recording unit;
an identification number reading step of reading out, from the server certificate, an identification number used to identify said server certificate;
a certificate judgment step of judging the validity of the server certificate by comparing the read-out identification number with the revocation number stored by the recording unit; and
a communication control step of establishing a communication with the server apparatus when the server certificate is judged to be valid, and of not establishing a communication with the server apparatus when the server certificate is judged to be invalid.

17. A program for a certificate issuing apparatus that issues a server certificate indicating validity of a server apparatus, the program causing a computer to execute the following steps:
a revocation number storage step of storing, into a recording unit, a revocation number that is information serving as a criterion for judging validity of the server certificate; and
an issuing step of issuing a new server certificate,
wherein in the issuing step, the new server certificate that includes an identification number is issued, the identification number indicating a value which is equal to or larger than the revocation number stored by the recording unit.
